(19) United States
(12) Patent Application Publication
(10) Pub. No.: US 2026/0061611 A1
(43) Pub. Date: Mar. 5, 2026

(54) MANAGEMENT OF MULTIPLE MODES FOR HUMANOID ROBOT

(71) Applicant: Figure AI Inc., San Jose, CA (US)

(72) Inventors: Michael Rose, San Jose, CA (US); Kyle Edelberg, San Jose, CA (US); Robert Gruendel, San Jose, CA (US)

(21) Appl. No.: 19/377,127

(22) Filed: Nov. 3, 2025

Related U.S. Application Data
(63) Continuation-in-part of application No. 19/033,973, filed on Jan. 22, 2025.
(60) Provisional application No. 63/626,105, filed on Jan. 29, 2024.
(60) Provisional application No. 63/626,030, filed on Feb. 21, 2024.
(60) Provisional application No. 63/626,028, filed on Feb. 27, 2024.
(60) Provisional application No. 63/626,035, filed on Feb. 27, 2024.
(60) Provisional application No. 63/564,741, filed on Mar. 13, 2024.
(60) Provisional application No. 63/626,034, filed on Mar. 13, 2024.
(60) Provisional application No. 63/634,697, filed on Apr. 16, 2024.
(60) Provisional application No. 63/707,547, filed on Oct. 15, 2024.
(60) Provisional application No. 63/708,003, filed on Oct. 16, 2024.
(60) Provisional application No. 63/714,989, filed on Nov. 1, 2024.
(60) Provisional application No. 63/839,688, filed on Jul. 7, 2025.

(51) Int. Cl. B25J 9/16; B62D 57/032

(52) U.S. Cl. CPC B25J 9/1661; B25J 9/163; B25J 9/1674; B62D 57/032

(57) ABSTRACT

The present disclosure provides a system for managing operational modes of a humanoid robot. The system comprises stateless controllers, each associated with a predefined operational domain defining a subset of robot state-space where the controller is valid. The system comprises composable modes with composable structures of stateless controllers arranged from highest to lowest priority. The system comprises a mode manager communicatively coupled to the stateless controllers and configured to, for each control cycle: iterate through the composable structure of an active composable mode from the highest-priority controller; select the first controller whose predefined operational domain includes the current robot state; and execute only the selected controller to control the humanoid robot for the control cycle duration.

### CROSS-REFERENCE TO RELATED APPLICATIONS

This application: (i) is a continuation-in-part from Ser. No. 19/033,973, filed Jan. 22, 2025, which claims priority to U.S. Provisional Patent Application Nos. 63/626,105, filed Jan. 29, 2024, 63/626,030, filed Feb. 21, 2024, 63/626,028, filed Feb. 27, 2024, 63/626,035, Feb. 27, 2024, 63/564,741, filed Mar. 13, 2024, 63/626,034, filed Mar. 13, 2024, 63/634,697, filed Apr. 16, 2024, 63/707,547, filed Oct. 15, 2024, 63/708,003, filed Oct. 16, 2024, and (ii) claims the benefit of and priority to U.S. Provisional Patent Application Nos. 63/714,989, filed Nov. 1, 2024, and 63/839,688, filed Jul. 7, 2025, each of which is fully incorporated herein by reference.

### TECHNICAL FIELD

This disclosure relates generally to the field of robot controls, and more specifically to systems and methods for managing multiple operational modes for a robot. The robot for which these modes are managed includes a plurality of hardware and software components.

### BACKGROUND

As humanoid robots become increasingly integrated into dynamic human environments, their operational capabilities are rapidly expanding. Driven by significant advances in artificial intelligence, including complex perception, reasoning, and action models, these machines are moving beyond simple, repetitive tasks. They are acquiring sophisticated levels of autonomy, enabling them to make independent decisions and perform goal-oriented behaviors in unstructured settings. This newfound capability, however, introduces a new layer of profound operational complexity. A single robot may be required to function in multiple distinct states, such as auto mode, human-guided teleoperation mode, or a standby mode for diagnostics and charging.

Challenge may arise at the seams of these operational states: the very moment of transition. An unmanaged or abrupt handover of control—for instance, switching from an autonomous state to a human-in-the-loop teleoperation mode—creates a significant risk of physical and computational instability. For a bipedal robot, a momentary lapse in control or a conflict in system logic during a switch can lead to kinetic instability, resulting in a fall that endangers the robot, nearby personnel, and its surroundings. This unpredictability during state changes can also lead to unintended environmental interactions or a complete failure to execute tasks. Therefore, a compelling need exists to address this predictability gap to ensure that these powerful, autonomous systems can operate and transition between their various modes in a manner that is fundamentally safe, reliable, and verifiable.

### SUMMARY

The presently disclosed subject matter is directed to a system for managing operational modes of a humanoid robot. Particularly, the system comprises a plurality of stateless controllers, each stateless controller associated with a predefined operational domain that defines a subset of a robot state-space wherein the stateless controller is valid. The system comprises at least one composable mode comprising a priority queue of two or more of the stateless controllers, arranged from a highest priority to a lowest priority. The system comprises a mode manager communicatively coupled to the plurality of stateless controllers and configured to, for each control cycle of the robot: iterate through the priority queue of an active composable mode, commencing from the highest-priority stateless controller; select a first stateless controller encountered during the iteration whose predefined operational domain includes a current state of the humanoid robot; and execute only the selected stateless controller to control the humanoid robot for the duration of the control cycle.

The presently disclosed subject matter is directed to a method for managing operational modes of a humanoid robot. Particularly, the method comprises defining a plurality of stateless controllers, each associated with a predefined operational domain that defines a subset of a robot state-space wherein the controller is valid. The method comprises defining at least one composable mode comprising a priority queue of two or more of the stateless controllers, arranged from a highest priority to a lowest priority. The method comprises executing a control loop wherein, for each control cycle: iterating through the priority queue of an active composable mode, commencing from the highest-priority stateless controller; selecting a first stateless controller encountered whose predefined operational domain includes a current state of the humanoid robot; and executing only the selected stateless controller to control the humanoid robot for the duration of the control cycle.

The presently disclosed subject matter is directed to a method for managing operational mode transitions in a humanoid robot. Particularly, the method comprises receiving, at a mode manager, a request to transition from a current operational mode to a requested operational mode. The method comprises in response to the request, performing a stability check to verify if the humanoid robot is in a predefined stable state. The method comprises in response to the stability check failing, executing a corrective action to command the humanoid robot to actively move into the predefined stable state. The method comprises gating the transition by switching control from the current operational mode to the requested operational mode only after the humanoid robot is verified to be in the predefined stable state, either from the initial stability check or following completion of the corrective action.

The presently disclosed subject matter is directed to a mode-management system for a humanoid robot. Particularly, the system comprises a shared state object accessible to a plurality of controllers. The system comprises a set of stateless robot modes, each mode defining an operational domain over a common state-space. The system comprises a composable controller configured to: maintain a priority queue of the stateless robot modes; and at each control tick, select a highest-priority mode whose operational domain includes a current robot state to generate control outputs. Each mode's operational domain is resource-aware and parameterized by internal resource signals, including at least remaining battery energy and computational load, such that the domain of energy-intensive modes contracts as resources decline, biasing selection toward lower-energy modes. Priorities in the priority queue are dynamically re-weighted by an overseer based on task context, including whether the robot is carrying a payload. A safe-fall mode having an effectively infinite domain serves as a fallback when no higher-priority domain is satisfied. Proximate to domain boundaries, controller outputs from multiple modes are blended according to degrees of domain membership to yield smooth behavior.

The presently disclosed subject matter is directed to a computer-implemented method for safely handing control between autonomy and human-in-the-loop operation in a humanoid robot. Particularly, the method comprises maintaining a continuous control-authority parameter spanning from fully manual to fully autonomous control. The method comprises upon a requested change of control authority or mode, computing, via a probabilistic transition gate, a transition-safety confidence given sensor and state uncertainty. The method comprises in response to the transition-safety confidence being below a predetermined threshold, commanding a learned pre-handover posture generated by an AI transition-model trained on successful and unsuccessful handovers. The method comprises while the robot converges to the pre-handover posture, re-evaluating the transition-safety confidence using an asynchronous, non-blocking transition protocol. The method comprises completing the handover only after the transition-safety confidence exceeds the predetermined threshold and a bidirectional handshaking check verifies operator link and environmental readiness.

The presently disclosed subject matter is directed to a method for managing operational states of a humanoid robot. Particularly, the method comprises receiving, at a mode manager, a user-requested mode for the humanoid robot. The method comprises determining whether the user-requested mode is different from a current mode of the humanoid robot. The method comprises in response to determining that the user-requested mode is different from the current mode, verifying that the humanoid robot is in a stable position by checking a plurality of stability criteria. The method comprises switching the humanoid robot to the user-requested mode only after verifying that the humanoid robot is in the stable position.

The presently disclosed subject matter is directed to a humanoid robot system. Particularly, the system comprises a plurality of sensors configured to collect data about a state of the humanoid robot. The system comprises a processor. The system comprises a memory storing instructions that, when executed by the processor, cause the system to: maintain a plurality of discrete operational modes, wherein each operational mode implements a specific set of behaviors; receive a request to transition from a current mode to a requested mode; and execute a transition protocol configured to: verify that the humanoid robot is in a stable position by checking a plurality of stability criteria based on data from the plurality of sensors; and permit the transition to the requested mode only after verifying that the humanoid robot is in the stable position.

The presently disclosed subject matter is directed to a method for controlling a humanoid robot. Particularly, the method comprises maintaining a plurality of stateless modes, wherein each stateless mode establishes a specific operational domain over which that mode can operate. The method comprises organizing the plurality of stateless modes into a priority queue with predetermined priorities. The method comprises at each control tick: accessing a current state of the humanoid robot from a shared state object; selecting a highest-priority mode from the priority queue whose operational domain includes the current state; and generating control outputs for the humanoid robot using the selected highest-priority mode.

The presently disclosed subject matter is directed to a humanoid robot control system. Particularly, the system comprises a shared state object configured to store a current state of a humanoid robot, including measured joint positions, velocities, and torques. The system comprises a plurality of stateless robot modes, wherein each mode defines an operational domain. The system comprises a composable controller configured to: maintain a priority queue of the plurality of stateless robot modes; at each control tick, select a highest-priority mode from the priority queue whose operational domain includes the current state accessed from the shared state object; and generate control outputs using the selected highest-priority mode.

In some embodiments, the control system architecture relies on a shared state object or blackboard, which all stateless controllers in a composable mode can access for the current state of the robot. This shared state object, in some embodiments, includes measured joint positions, velocities, and force/torque sensor readings. In some embodiments, the shared state object further includes estimated robot state information, such as contact state, robot pose, and end effector force estimates. Control outputs, in some embodiments, are provided to a whole body controller and actuator controllers. In these embodiments, the control outputs update a desired robot state that is accessible through the shared state object, thereby creating a closed-loop control system.

In some embodiments, the system utilizes a plurality of stateless robot modes, which may comprise a stand mode for balance control, a walk mode for locomotion control, and a safe fall mode as a fallback controller. In some embodiments, the plurality of robot modes or stateless controllers further comprises a “wiggle mode.” This wiggle mode, in some embodiments, is configured for joint-level debugging by cycling through predetermined joint positions, or in other embodiments, for system diagnostics or gain tuning by commanding a predefined oscillatory motion. These modes are defined by their operational domains: in some embodiments, the stand mode domain requires both feet on the ground with zero-step capturability and zero desired velocity. The walk mode domain, in some embodiments, requires at least one foot on the ground and a measured velocity below a predetermined maximum walking speed. The safe fall mode, in some embodiments, has an effectively infinite operational domain to serve as a fallback. In some embodiments, a predefined operational domain may also be resource-aware, dynamically contracting or expanding based on internal states like battery power or computational load.

In some embodiments, these stateless controllers are organized into a composable mode, such as a priority queue or, in some embodiments, a behavior tree. This queue, in some embodiments, includes a fallback controller at the lowest priority with an operational domain encompassing the entire state-space, ensuring a stateless controller is always selected. For example, in some embodiments, a composable “stand queue” comprises, in decreasing priority: a stand mode controller, at least one step-recovery controller, and a safe fall mode. In other embodiments, a “walk queue” comprises a centroidal model predictive control (MPC) mode, a stand mode, and the fallback. In some embodiments, a mode manager selects the highest-priority controller whose domain is valid. This allows dynamic behavior; in some embodiments, in response to a perturbation, the system selects a step-recovery controller, and in a subsequent cycle, automatically re-selects the stand mode when the state re-enters its domain. In some embodiments, the method comprises dynamically re-weighting priorities based on a task context, such as carrying a payload, which in some embodiments is handled by an overseer system.

In some embodiments, transitions between a plurality of discrete operational modes (which, in some embodiments, comprise an autonomous mode, a semi-auto/assisted manual mode, and a maintenance mode) require a stability check. In some embodiments, verifying the robot is in a predefined stable state comprises confirming physical criteria: that the robot is stationary, its center of mass is within its support polygon, and its velocity is below a threshold. In some embodiments, the stability criteria also comprise computational criteria, such as performing a system-wide self-check of sensors and actuators or confirming the state estimator has converged with low uncertainty. In some embodiments, environmental criteria are also checked, such as verifying a stable, low-latency communication link if the requested mode is semi-auto/assisted manual. In some embodiments, if this check determines the robot is not in the stable position, the method initiates a corrective action, which in some embodiments comprises executing a pre-defined stable posture maneuver. In some embodiments, this stability check is executed by a dedicated AI model, and the corrective action comprises a learned “pre-handover” maneuver.

This switching logic, in some embodiments, is handled asynchronously: the system acknowledges the request, performs the check and corrective action in a non-blocking background process, and sends a completion notification only after the switch. In some embodiments, the stability check and corrective action are bypassed if the requested mode is an emergency fail-safe mode. In other embodiments, if both the stability check and the corrective action fail to achieve the predefined stable state, the method comprises selecting a context-aware fallback mode based on the current environmental context.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a diagram depicting an interaction of components contained within a computing architecture of the humanoid robot of FIGS. 1-3B;

FIG. 10 is a first embodiment of a mode manager that is configured to manage a plurality of robot modes and the switches between said modes;

FIG. 11 is a diagram showing the managed switching between various operational modes, which is orchestrated by the mode manager of FIG. 10;

FIG. 12 is a second embodiment of a mode manager that is configured to manage a plurality of robot modes and the switches between said modes;

FIG. 13 is a diagram showing the operation of a distinctive wiggle mode by a humanoid robot;

FIG. 14 is a third embodiment of a mode manager that is configured to manage a plurality of robot modes and the switches between said modes;

FIG. 15 is a block diagram illustrating various control modes under the automatic operational mode that may be used by the mode manager of FIG. 14;

FIG. 16A-16D are block diagrams showing various controller queues that may be employed by the mode manager of FIG. 14; and

FIG. 17 is a block diagram illustrating a behavior tree that may be utilized by the mode manager of FIG. 14.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

With the rapid spread of advanced artificial intelligence, including complex vision-language-action models and dual-process cognitive models, humanoid robots are actively acquiring highly sophisticated autonomous capabilities. However, this remarkable progress introduces significant challenges in ensuring the operational safety and predictability of these systems, especially during transitions between different operational states. An unmanaged or sudden switch between modes, for example, from a fully autonomous mode to a direct, human-assisted teleoperation mode, can potentially lead to kinetic instability, unintended interactions with the environment, or a complete failure to carry out tasks, thereby posing a risk to the robot, its surrounding environment, and foreign objects within its proximity. The disclosure that follows proposes robust methods and systems for managing operational states and ensuring safe mode transitions for the humanoid robot.

To ensure the moral and ethical integrity of a humanoid robot, a strategic AI guardian may be implemented as the highest layer of a hierarchical control system. This guardian may function as a moral and ethical override, continuously assessing all planned actions against a primary directive to prevent harm to living beings. It may possess the authority to veto any command, whether originating from the robot's autonomous systems or a human operator, that could foreseeably lead to harm, thereby ensuring that safety principles are never compromised by operational commands.

This disclosure also reveals that the functionality of humanoid robots can be primarily managed by a mode manager through three principal operational modes. An autonomous mode allows the robot to perform complex tasks independently, utilizing its onboard sensors and AI. A semi-auto/assisted manual mode permits a human operator to assume direct control, which is ideal for managing unpredictable situations or for gathering data to train the robot's AI. Lastly, a maintenance mode is a restricted state for non-task-related activities such as charging and diagnostics, and it may also incorporate a fail-safe function that can immediately stop all motion in response to a critical error or an emergency command.

The transition between these operational modes may be a securely guarded process overseen by the mode manager. This mode manager ensures that no mode switch is allowed until the robot has reached a predefined “stable position.” Such prerequisites can prevent hazardous situations, for example, attempting a control handover while the robot is in motion. During a mode transition, the mode manager may start by checking if a requested mode is different from the current one. If so, it first confirms the robot's stability. If the robot is not stable, it is instructed to move to a stable position before the mode switch can be executed and verified.

The proposed definition of a stable position is context-dependent and serves as a universal prerequisite for any mode change. For transitions between active modes, such as autonomous and semi-auto/assisted manual, the necessary stable position may be one where the robot is stationary but fully powered. For transitions into maintenance mode, a more significant level of stability is needed, such as a state where the system's compute power is disconnected. For maintenance or emergency scenarios, the required state may involve engaging a physical energy isolating device, which provides the highest possible level of isolation by creating a verifiable hardware-level power disconnect.

Within the autonomous operational mode, additional granularity is achieved through a plurality of specific “controller modes,” which act as sub-modes. The mode manager is engineered to handle these sub-modes by offering reusable and parameterizable components of robot functionality. Its main responsibilities include determining whether a requested controller mode can be activated based on the current system state and inputs, and then coordinating the activation of that new mode. This design allows for specialized sub-modes, for instance, a “Wiggle Mode” for startup diagnostics. Furthermore, the mode manager may also manage the activation of a fallback controller mode, ensuring that the robot can return to a known safe behavior if a contingency occurs.

A primary architectural feature of the autonomous mode is the capability to sequentially compose these smaller controller sub-modes to form more complex and robust behaviors. Instead of depending on large, monolithic controllers for each specific task, the mode manager can analyze multiple composed controllers and choose the one whose operational domain is valid for the current robot state and inputs. This composability enables the robot to dynamically adapt to external disturbances and contingencies, which significantly increases the robustness of the control system by ensuring each controller operates only within a sub-state for which it is valid and expanding the robot's overall basin of attraction.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

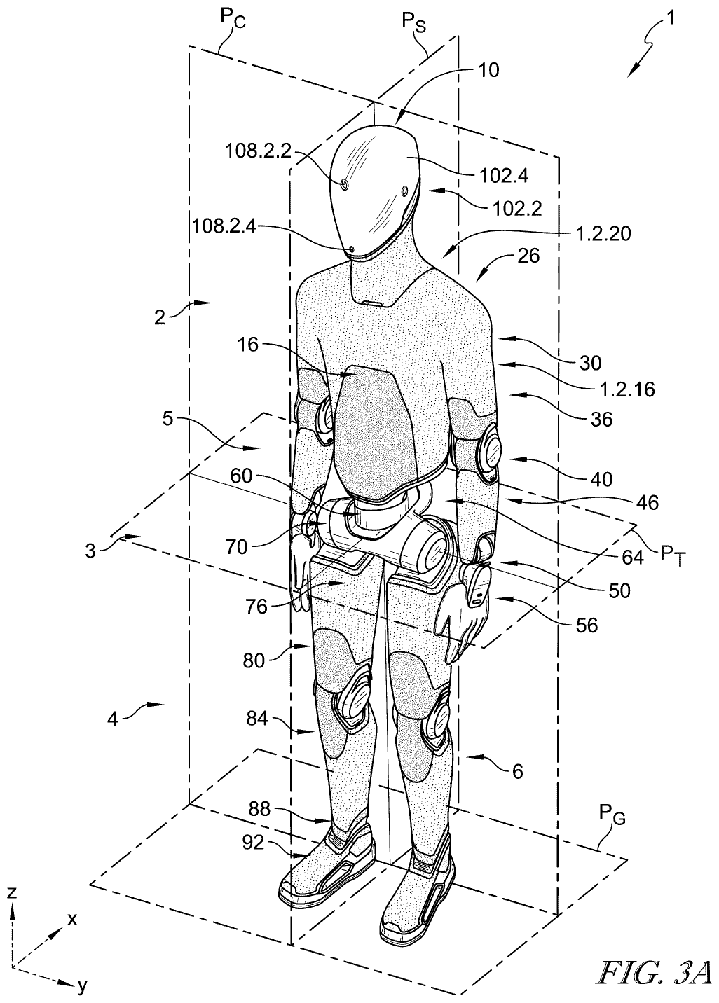

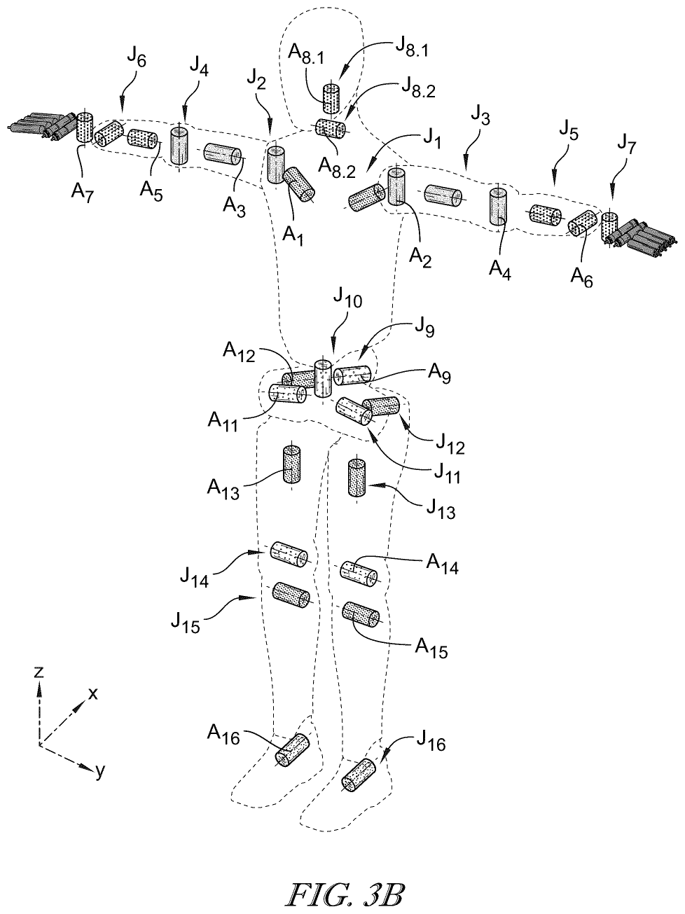

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bn): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

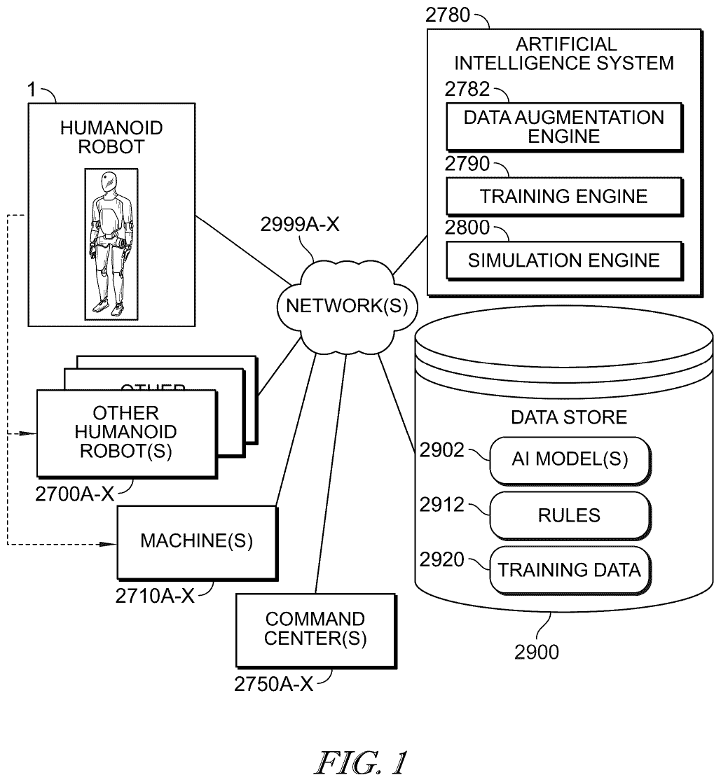

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-based AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

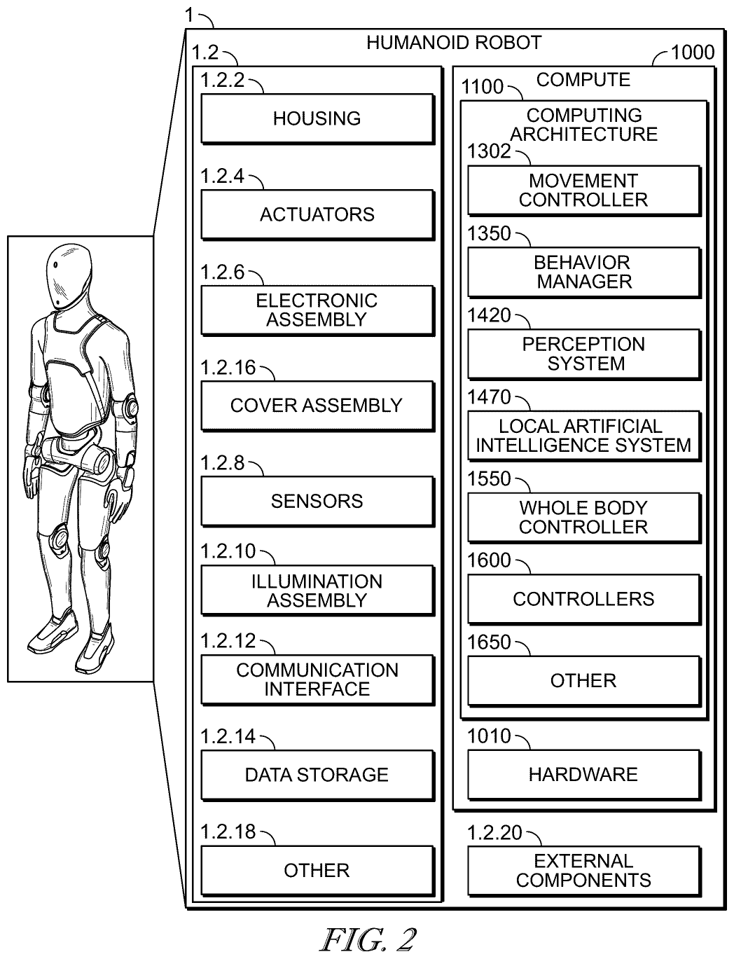

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

### i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm | upper arm x, upper arm roll | A₃ |
| | | twist | | |
| (J4) 374 | 2 | elbow | arm z, arm yaw, lower humerus | A₄ |
| (J5) 468 | 2 | lower arm | lower arm x, lower arm roll | A₅ |
| | | twist | | |
| (J6) 484 | 2 | wrist flex | wrist/hand y, wrist/hand pitch, | A₆ |
| | | | flick | |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second | A₁₆ |
| | | | ankle | |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

### ii. Sensors

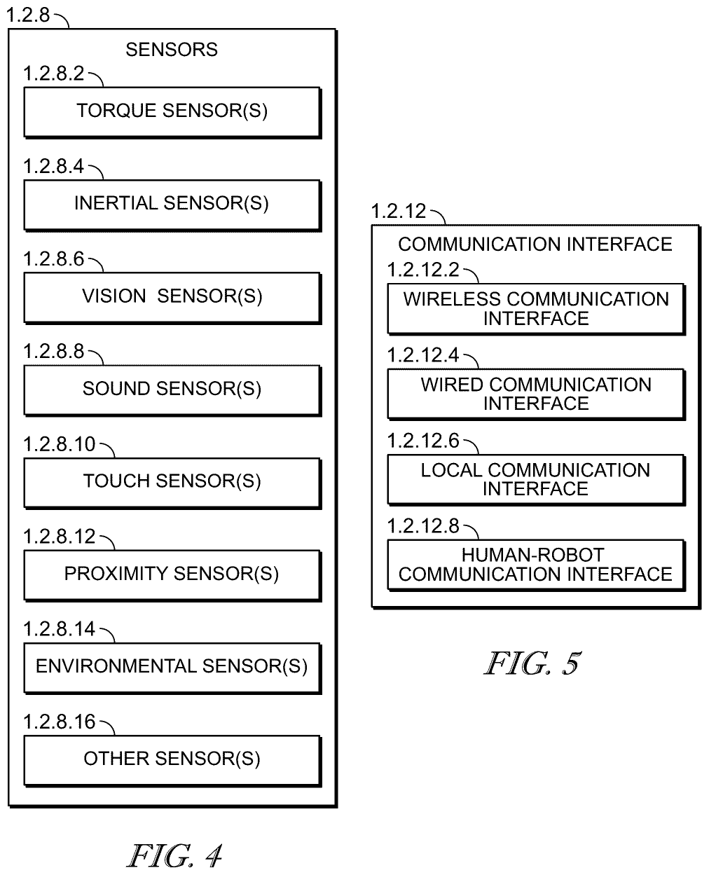

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

### c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

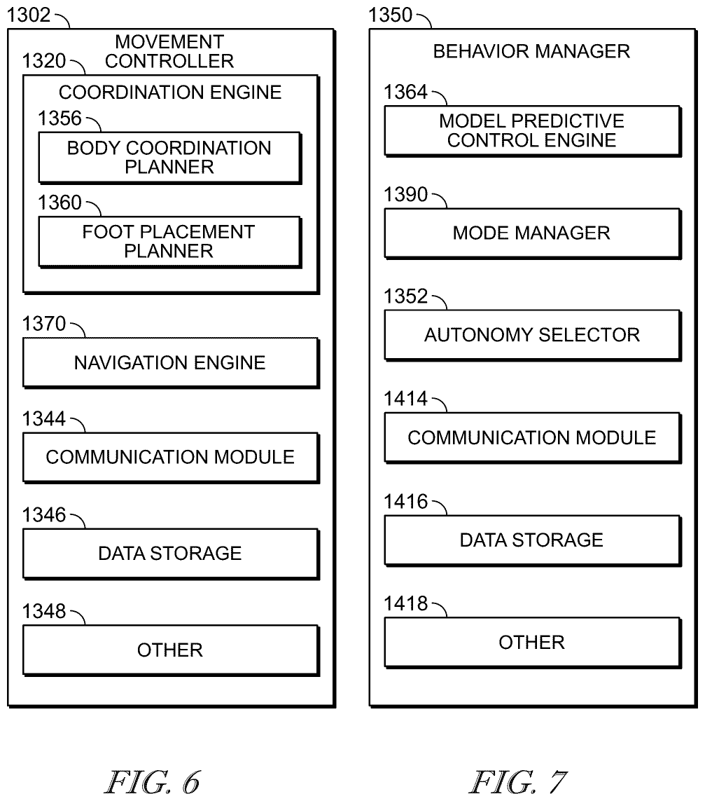

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

### 4. Local AI system

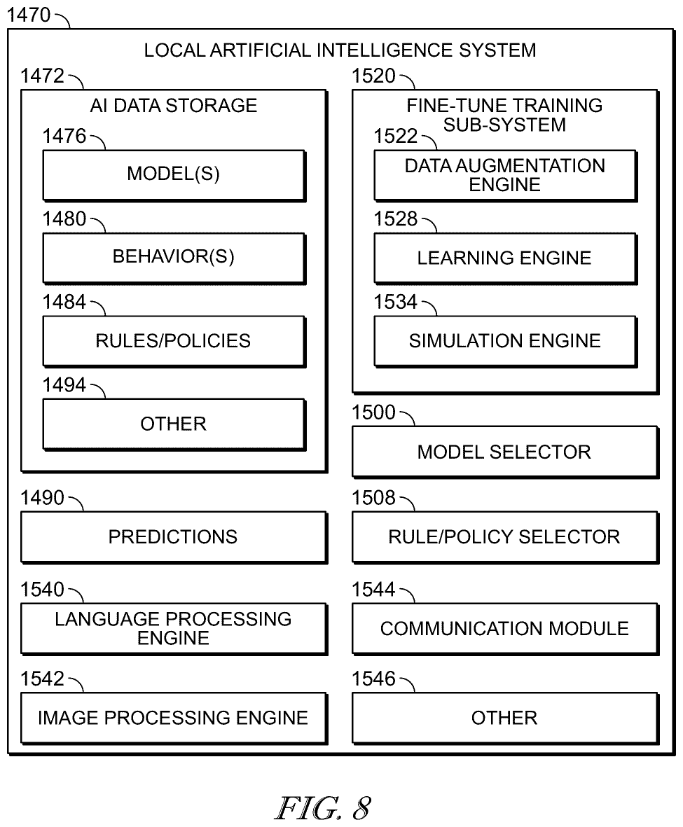

The local AI system 1470 may be embodied as any combination of hardware, software, or circuitry to drive semi-to fully-autonomous perception, learning, and behavior by the humanoid robot 1. The local AI system 1470 may implement various operational configurations wherein: (i) models or architectures run exclusively on the disclosed local AI system 1470, (ii) models or architectures execute with a portion running on the local AI system 1470 and another portion running on the remote AI system 2780, enabling distributed processing capabilities that leverage both edge and cloud computing resources for optimal performance, and (iii) models or architectures run exclusively on the disclosed remote AI system 2780, with the local AI system 1470 serving as an interface for command transmission and data relay. The local AI system 1470 receives detailed description in connection with FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600), establishing bidirectional data flows and control pathways throughout the robotic architecture. In some embodiments, the compute 1000 may only include or primarily include the local AI system 1470, wherein the AI system serves as the central computational hub for all robotic functions. In other words, the local AI system 1470 may not be considered a separate component or system, but instead an integral component of other systems contained within the compute 1000, providing unified intelligence across all subsystems. Thus, a primary technical issue solved by the local AI system 1470 is the challenge of real-time, context-aware decision-making in dynamic environments. Traditional robotic systems often rely on pre-programmed responses or remote processing, which can lead to delays or inappropriate actions in dynamic situations where environmental conditions change rapidly. The local AI system 1470 overcomes this limitation by enabling rapid, localized processing of sensory inputs and the immediate generation of appropriate responses through parallel processing pathways and optimized data structures that minimize latency between perception and action.

Another technical challenge addressed by the local AI system 1470 involves the integration and interpretation of multi-modal sensory data from heterogeneous sources. The humanoid robot 1 employs various sensors, including visual, auditory, tactile, and proprioceptive systems, each operating at different sampling rates and producing data in distinct formats. The AI system 1470 efficiently fuses these diverse data streams in real-time, creating a comprehensive and coherent representation of the state of the robot 1 and its environment through techniques such as temporal alignment, sensor fusion algorithms, and hierarchical data aggregation that reconcile different data modalities into a unified world model. This integrated perception allows for more nuanced and accurate interactions with the physical world and human collaborators, enabling the robot to understand complex scenarios that require simultaneous processing of multiple sensory inputs. The local AI system 1470 also addresses the technical challenge of adaptive learning and continuous improvement in unstructured environments. Unlike static systems, this local AI system 1470 can modify its behavior based on experience and feedback through iterative refinement processes that incorporate both supervised and unsupervised learning paradigms. The system employs advanced machine learning algorithms, potentially including deep reinforcement learning and online learning techniques, to continuously refine its decision-making processes while maintaining stability and safety constraints. This adaptability allows the robot 1 to improve its performance over time, learn new tasks with minimal explicit programming, and adjust to changes in its operational environment or physical capabilities, such as wear on actuators or modifications to its hardware configuration. A further technical challenge resolved by the local AI system 1470 involves the efficient management of the limited computational resources of the robot 1, particularly when operating in autonomous mode without cloud connectivity. The AI system 1470 implements sophisticated task prioritization and resource allocation algorithms, ensuring that time-sensitive processes receive adequate computational power while less urgent tasks are managed efficiently through dynamic scheduling and load balancing mechanisms that adapt to changing computational demands. This dynamic resource management enables the robot 1 to maintain optimal performance across a wide range of operational scenarios, from simple repetitive tasks to complex problem-solving situations that require extensive computational resources.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. These models 1476 may include convolutional neural networks for visual processing, recurrent neural networks for temporal sequence analysis, transformer architectures for multi-modal understanding, and hybrid architectures that combine multiple model types for specialized tasks. The illustrative model selector 1500 selects an appropriate model or set of models 1476 given a specified task, scenario, or constraint, utilizing a meta-learning approach that considers historical performance data and current operational conditions. For example, the model selector 1500 may select a given model based on considerations such as the task complexity, a cost to perform the task including computational and energy costs, performance efficiency metrics including latency and throughput requirements, the environment and surroundings characteristics including lighting conditions and obstacle density, resource management requirements including available memory and processing power, or the current health status of the humanoid robot 1 or its components including battery level and actuator conditions. Over time, the model selector 1500 may be refined based on learning algorithms that identify efficient models 1476 for given tasks, scenarios, and constraints through performance tracking and optimization feedback loops that analyze success rates, resource utilization, and task completion times. In an embodiment, the model may be selected in response to operator input as an alternative to automated selection, providing human oversight when desired. This manual selection capability may be useful, e.g., during the initialization of the humanoid robot 1 or during specialized operational modes such as debugging, maintenance, or experimental task execution.

The illustrative rule and policy selector 1508 may select one or more of the rules and policies 1484 that are stored in the AI data storage 1472 to be enforced during the operation of the humanoid robot 1, e.g., based on operator input given a context, environment, compliance and regulatory jurisdiction, safety considerations, and operational parameters. These rules and policies 1484 may include safety constraints that prevent the robot from entering dangerous states, ethical guidelines that govern interactions with humans, operational boundaries that define acceptable ranges of motion and force application, and task-specific protocols that ensure consistency in execution. In an embodiment, the rule and policy selector 1508 may automatically learn efficient methods for adapting to selected rules and policies over time through reinforcement learning and pattern recognition algorithms that identify successful strategies for satisfying multiple, potentially conflicting constraints.

The language processing engine 1540 may be embodied as any combination of hardware, software, or circuitry for obtaining, parsing, interpreting, and understanding natural language directives and concepts, and also for generating natural language speech that enables bidirectional communication with human operators. For example, the language processing engine 1540 may translate speech-to-text and text-to-speech through acoustic modeling, language modeling, and pronunciation modeling components, utilizing deep learning architectures such as transformer-based models for contextual understanding and sequence-to-sequence models for translation tasks. The language processing engine 1540 may also incorporate semantic parsing capabilities to extract structured representations from unstructured text, enabling the robot to understand complex commands with multiple sub-goals and conditional logic. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors such as cameras or in preloaded training data). The image processing engine 1542 may utilize convolutional neural networks, vision transformers, and hybrid architectures that combine local and global feature extraction for comprehensive visual understanding across multiple scales and resolutions.

The training sub-system 1520 may be embodied as any hardware, software, or circuitry configured to refine models 1476 and behaviors 1480 based on observed data and training data, enabling continuous improvement of the robot's capabilities through experience. The training sub-system 1520 may include a data augmentation engine 1522, a learning engine 1528, and a simulation engine 1534. The data augmentation engine 1522 may be embodied as any hardware, software, or circuitry configured to increase the size and diversity of training data through techniques such as rotation, scaling, cropping, and synthetic data generation, similar to the data augmentation engine 2782 of the remote AI system 2780. The data augmentation engine 1522 may also employ advanced techniques such as style transfer to create visually diverse training samples, adversarial examples to improve robustness, and procedural generation to create entirely synthetic training scenarios. The learning engine 1528 may be embodied as any hardware, software, or circuitry for training the AI models 1476, given a set of rules and policies 1484, behaviors 1480, and training data, similar to the training engine 2790 of the remote AI system 2780. The learning engine 1528 may implement various optimization algorithms including stochastic gradient descent, Adam, and second-order methods, along with regularization techniques such as dropout, batch normalization, and weight decay to prevent overfitting. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. The simulation engine 1534 may incorporate physics engines for accurate dynamics simulation, sensor models for realistic perception simulation, and environmental models for testing the robot's performance under various conditions. Compared to the remote AI system 2780, the AI fine-tuning conducted by the local AI system 1470 may be localized to the specific humanoid robot 1, which can be advantageous in situations such as those where the humanoid robot 1 performs a specific task repeatedly or operates in a consistent environment, allowing for highly specialized optimization that would not generalize well to other robots in the fleet.

The other 1546 may include a communications module that is embodied as any combination of hardware, software, and/or circuitry to enable components of the local AI system 1470 to communicate with one another and with other components of the humanoid robot 1 (such as of the compute 1000). The communications module may implement various protocols including high-speed serial interfaces, shared memory architectures, and message-passing systems to ensure low-latency data transfer between components. It should be understood that the controllers may be omitted and/or consumed by one or more models (e.g., RL trained models) that are contained within the local AI system 1470, providing end-to-end learning capabilities that directly map from sensory inputs to motor commands.

### 5. Whole Body Controller

The whole body controller 1550 may be embodied as any combination of hardware, software, or circuitry for receiving information from the behavior manager 1350 or the local AI system 1470 and translating high-level commands into coordinated full-body motion. The whole body controller 1550 may thereafter send the information to other components of the compute 1000, ensuring synchronized control across all robot subsystems. For example, the whole body controller 1550 may transmit joint torque data, which represents data pertaining to rotational forces exerted at “joints” of the humanoid robot 1, to the controllers 1600, implementing torque limits and safety margins. The whole body controller 1550 may implement various control strategies including computed torque control, impedance control, and admittance control, selecting the appropriate strategy based on task requirements and environmental interactions, the whole body controller 1550 may be omitted and/or consumed by one or more models (e.g., RL trained models) that are contained within the local AI system 1470, providing end-to-end learned control.

The controllers 1600 may be embodied as any combination of hardware, software, and/or circuitry for transmitting joint torque data to the actuators 1.2.4, e.g., to extend and retract parts (such as arms, hands, fingers of the humanoid robot 1), with precise timing and coordination. The controllers 1600 may also infer joint torque and angle data received from other sensors 1.2.8, such as IMUs mounted on a given “body part,” providing redundant sensing for increased reliability. In some embodiments, the joint torque and angle data may be measured using rotary position sensors, optical reflection, or other methods, with sensor fusion algorithms combining multiple measurements for improved accuracy. The whole body controller 1550 may also incorporate advanced control strategies, such as passivity-based control or adaptive control, to ensure stability and robustness in the presence of uncertainties or external disturbances, automatically adjusting control parameters based on detected environmental conditions, the controllers 1600 may be omitted and/or consumed by one or more models (e.g., RL trained models) that are contained within the local AI system 1470, enabling direct neural control of actuators.

### 6. Other

Other components 1650 of the compute 1000 may include components not discussed above relative to the compute 1000, such as power management modules (e.g., to manage battery pack health, manage power usage profiles, implement predictive power optimization, etc.) and calibration modules (e.g., to ensure that actual kinetic movements of the humanoid robot 1 align with the expected kinetic movements determined based on calculations), maintaining system accuracy over time. The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices, thermal management systems for heat dissipation, and diagnostic interfaces for maintenance and troubleshooting.

### d. Interaction Between Components of the Computing Architecture

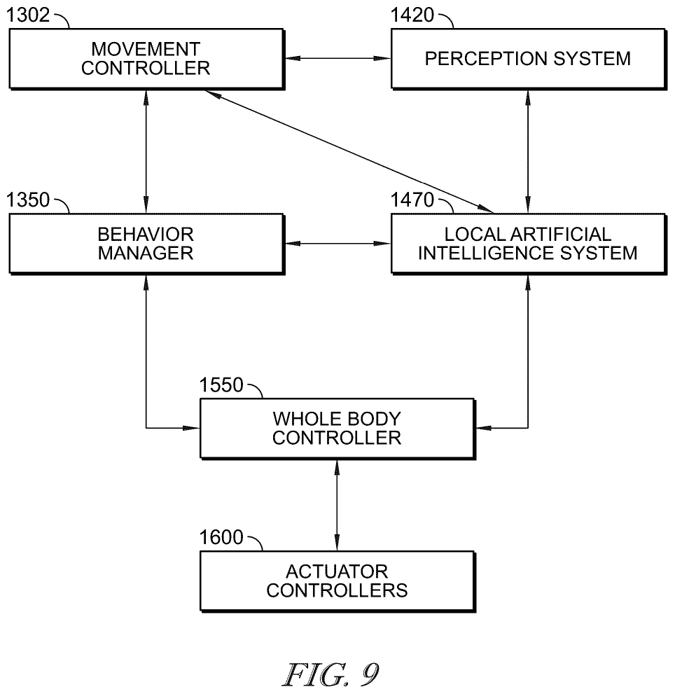

FIG. 9 depicts interactions between components of the humanoid robot 1 during its operation, illustrating the complex information flow and control hierarchy. Upon startup of the humanoid robot 1, the humanoid robot 1 may be in a standby mode or may otherwise remain idle in an initial position (e.g., standing, sitting, lying down, etc.), with all systems performing self-diagnostics and initialization procedures. The robot 1 may initialize and activate its sensors 1.2.8 and obtain data in relation to the environment and surroundings of the robot 1, as well as positional data, audiovisual data, and the like, establishing baseline measurements and calibrating sensor offsets. The movement controller 1302 may obtain data from its environment using the perception system 1420, while understanding the location and position of the robot 1 within said environment through localization algorithms and map building.

The environmental data, along with the robot data, can be fed into: (i) the local AI system 1470 and (ii) the behavior manager 1350, creating parallel processing pathways for different aspects of robot control. The local AI system 1470 can then convert speech to text in order to obtain long-horizon goals, wherein said local AI system 1470 can subdivide these long-horizon goals into one or more sub-goals or tasks through hierarchical task decomposition. The local AI system 1470 can then check with the behavior manager 1350 to confirm that the robot 1 maintains the correct state for performing the first sub-goal or task, ensuring preconditions are met. Once the state of the robot 1 becomes confirmed or the state of the robot 1 changes to be in the right state, the local AI system 1470 can determine the movements and actions to perform for a given specified task, generating motion plans that satisfy kinematic and dynamic constraints.

Each of the interacting components may provide feedback information to each other as the movements or actions are being performed, creating a robust closed-loop control system. For example, the perception system 1420 may relay an indication to the movement controller 1302 that a given task has completed based on audiovisual data received during the performance of an action or movement, enabling task monitoring and verification. As another example, the behavior manager 1350 may be in continuous communication with the whole body controller 1550 to ensure that the movement and positioning of the robot 1 remain as instructed and/or planned by the local AI system 1470, providing real-time corrections for disturbances. As yet another example, the local AI system 1470 may continuously receive data from the perception system 1420, the movement controller 1302, the behavior manager 1350, and the whole body controller 1550 and use the data to refine and optimize the currently executing model given present configurations, conditions, and constraints, implementing online learning and adaptation, the movement controller 1302, behavior manager 1350, perception system 1420, whole body controller 1550, and/or controllers 1600 may be omitted or replaced in alternative embodiments, depending on the specific architectural choices and control paradigms employed.

### E. Mode Manager

Disclosed herein are systems, methods, and processes for managing operational states and ensuring safe mode transitions for an advanced humanoid robot. This disclosure addresses the safety and predictability challenges associated with sophisticated AI-driven autonomy. The system may be centered on a dedicated mode manager that governs a plurality of discrete operational modes. Safe transitions between these modes may be enforced by a protocol. This protocol may compel the robot to first achieve and verify a context-dependent position that ensures physical, computational, and environmental criteria are met before control is formally handed over. This transition management may be implemented using, for example, a stateful mode manager that checks if a requested mode (e.g., “walk” or “stand”) can accept a transition. Alternatively, the transitions may be handled by a composable, stateless architecture. In such an architecture, complex behaviors are created by organizing controllers into priority queues (e.g., a “stand queue” or “walk queue”). This arrangement allows the system to select the highest-priority controller whose operational domain matches the robot's current state, enabling a robust handling of tasks and perturbations.

### a. First Embodiment of the Mode Manager

The first embodiment is a stateful mode manager that is designed to control transitions between three primary modes. It should be understood that these three primary modes are only examples and, as such, other modes may be added (which are described below or are known in the art) and/or some of the above-listed modes may be omitted.

### i. Operational Modes

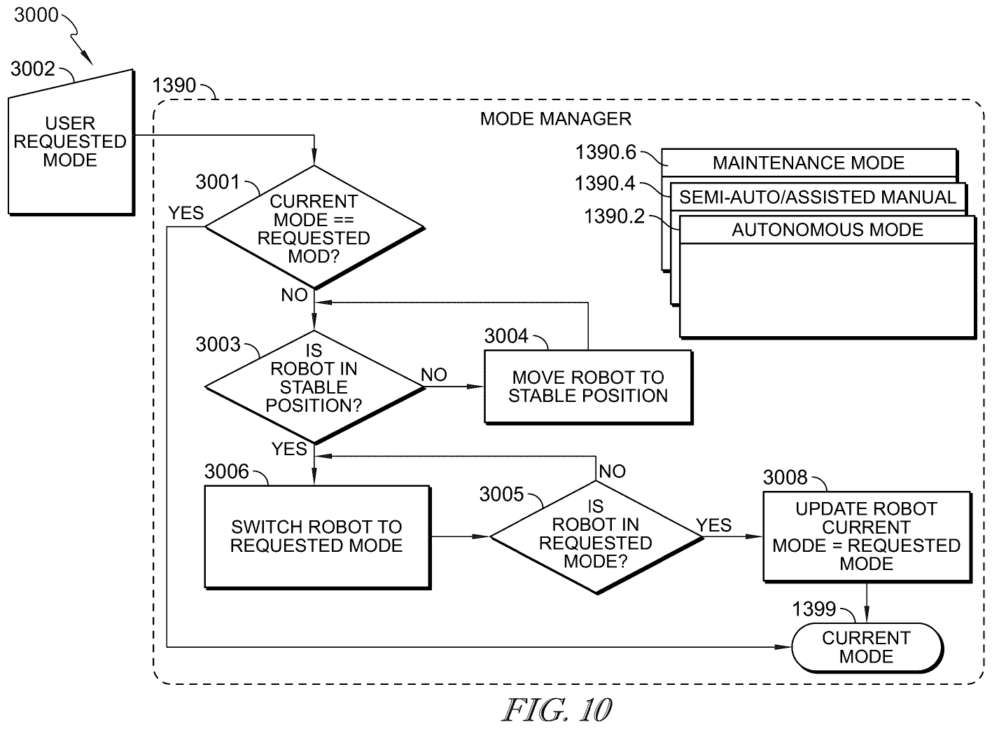

The computing architecture 1000 of the humanoid robot 1 may define a plurality of discrete operational modes to effectively manage the capabilities and internal state of the robot 1. These modes may be configured to implement a specific set of behaviors for the humanoid robot 1. The operational modes may exist on a spectrum of control, and the ability to transition between them safely is a design consideration. The primary operational modes may include an autonomous mode 1390.2, a semi-auto/assisted manual mode 1390.4, and a maintenance mode 1390.6, as illustratively referenced in FIG. 10.

### 1. Autonomous Mode

The autonomous mode 1390.2 may be defined by the capacity of the robot 1 for independent, goal-oriented operation. In this mode, the robot 1 may use its own internal logic to make decisions and execute high-level tasks without direct, real-time human intervention. In this mode, a main function is the autonomous execution of assigned tasks, intelligent navigation through complex and dynamic spaces, and interaction with the environment. This advanced capability may be supported by a sophisticated suite of onboard sensors 1.2.8, including high-resolution cameras and/or LiDAR, which provide a continuous stream of data to a unified AI-based decision-making system 1470, such as the Helix model 1476.2. The robot 1 may function based on a “perceive-reason-act” paradigm, employing predictive models of its environment to plan and carry out sequences of actions that achieve an asynchronous, high-level goal, such as the command “clean the table.” A characteristic of this mode is its self-directed and goal-oriented nature, which is driven by advanced sensor fusion techniques and sophisticated machine learning algorithms.

### 2. Semi-Auto/Assisted Manual Mode

The semi-auto/assisted manual mode 1390.4 may be distinguished by the complete transfer of direct, real-time control for the manipulators and mobility platform of the robot 1 to a human operator. The operator typically interacts with the robot 1 via a remote interface or a wearable data collection system. In a further embodiment, this mode 1390.4 may be subdivided into a “variable-assist manual mode” with multiple sub-modes. these may include “endpoint control teleoperation” 4322, where the operator specifies a desired 6-DOF pose for the hand of the robot 1, and the whole-body controller 1550 autonomously computes the joint movements and maintains balance. Another sub-mode may be “corrective teleoperation” 4324. In this sub-mode, the robot 1 operates autonomously, but the human provides real-time corrective inputs. These inputs are interpreted as a delta, or change, to the autonomous commands. This mode may be utilized for collecting training data for imitation learning, handling unpredictable “edge cases,” or performing complex, delicate tasks for which the robot 1. Characteristics of this mode include the utilization of a low-latency control link to ensure responsive command execution and the potential for haptic or force feedback to give the operator an immersive and intuitive sense of the physical interaction of the robot 1 with the environment. This human-in-the-loop architecture utilizes human intelligence to guide the actions of the robot 1, serving as a primary mechanism for teaching the robot 1 new and valuable skills.

### 3. Maintenance Mode

The maintenance mode 1390.6 may be characterized as a non-operational state that is dedicated to internal upkeep, self-preservation, general serviceability, or the immediate cessation of all activity for overriding safety reasons. This mode may cover both routine, scheduled procedures and unforeseen emergency conditions. In its routine capacity, its main function is to allow the robot 1 to perform essential non-task-related activities such as recharging its batteries, running system-wide self-diagnostics, calibrating its sensors, or receiving software updates, during which its motive functions are typically disabled or severely limited to ensure stability and safety.

This mode may also provide a terminal fail-safe condition with the highest priority and is designed to immediately prevent harm to personnel or damage to robot 1 or its surroundings. This emergency condition may be initiated by an unrecoverable system error detected by onboard diagnostics or by a direct emergency command from an operator. Upon the activation of this fail-safe condition, the maintenance mode 1390.6 may override all other operational modes or states. Once this emergency condition is triggered, the robot 1 may also be programmed to assume a pre-defined, stable, low-energy posture to await a manual inspection and a formal reset procedure, thereby ensuring that the system cannot resume operation until the root cause of the failure has been properly identified and resolved.

### ii. Operation of the First Embodiment

FIG. 10 is a block diagram of a mode manager 1390, and an associated flowchart 3000 for verifying a stable position (e.g., at block 3003) may be used to manage and switch between operational modes for a humanoid robot 1. The logic flow 3000 may start when the mode manager 1390 receives a user-requested mode (block 3002). The first logical check (block 3001) ascertains if the current mode is the same as the requested mode. If it is, no action is performed, and the mode manager 1390 remains in the current mode (block 1399). If the requested mode is different, the system moves to the next safety check (block 3003), which verifies if the robot 1 is in a stable position. This stability check serves as the primary gatekeeper for ensuring safe mode transitions. If the check at block 3003 finds that the robot 1 is not in a stable position, the mode manager 1390 may initiate a corrective action (block 3004) to actively move the robot 1 to a stable position. This step ensures that the robot 1 attains a verified state of both physical and computational stability before any handover of control is attempted. This transition protocol may be conceptualized as a negotiated handshake between the controller of the current mode, the controller of the target mode, and a supervisory safety layer, ensuring that all pre-agreed conditions are met before control is formally ceded from one controller to the other. This enforced logic may prevent the occurrence of hazardous conditions, such as a moving robot attempting to switch its motion controllers mid-stride or a robot with a known sensor fault trying to initiate a complex autonomous task.

Once stability is confirmed, either initially or after the corrective action, the process moves to switch the robot 1 to the requested mode (block 3006). Following the switch command, a verification check is performed (block 3005) to confirm if the robot 1 has successfully transitioned to the requested mode. If the transition was not successful for any reason, the system may loop back to re-attempt the switch command. If the transition was successful, the final action (block 3008) is to update the current mode of the robot 1 to be the requested mode, after which the mode manager 1390 may settle into its new current mode (block 1399), which could be the autonomous mode 1390.2, the semi-auto/assisted manual mode 1390.4, or the maintenance mode 1390.6.

### 1. Specific Examples of Said Operation

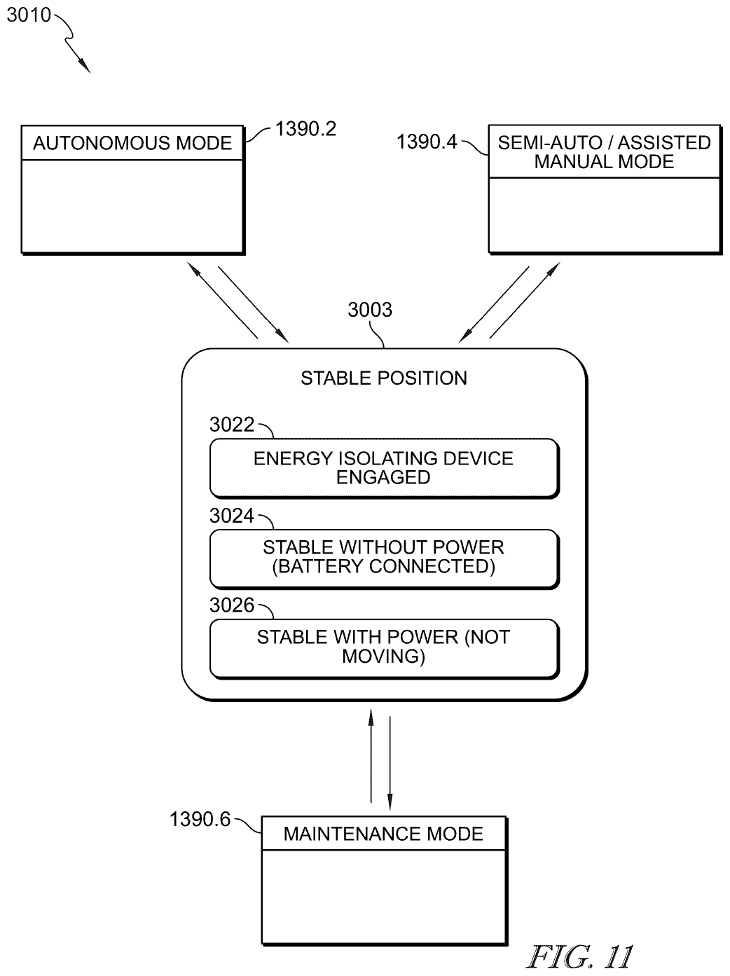

FIG. 11 is a diagram showing exemplary switching events between various operational modes, as orchestrated by the mode manager 1390 of FIG. 10. Specifically, the relationship 3010 illustrates how at least a majority of the transitions between the operational modes 1390.2, 1390.4, and 1390.6 are mediated through a centrally managed set of defined stable position 3003. A transition from the autonomous mode 1390.2 to the semi-auto/assisted manual mode 1390.4 may exemplify this protocol. This handover may be permitted to proceed only after the robot 1 meets a set of physical, computational, and environmental stability criteria (3026). For instance, the pre-transition stable position may demand that the robot 1 be physically stationary and balanced, with its center of mass confirmed to be well within its support polygon boundary and its velocity measured to be at or close to zero. The supervisory system, such as the mode manager 1390, may also verify that the surrounding environment is safe for the handover and that a stable, low-latency communication link to the operator's console has been successfully established and verified. Furthermore, the stability criteria may include task-based criteria, such as verifying that a payload is secure or that a tool is properly stowed before a transition is permitted. The transition protocol orchestrated by the mode manager 1390 may then commence, with the robot 1 first pausing its current autonomous task and formally acknowledging the operator's handover request. Only then does the robot 1 relinquish primary motor control to the teleoperation interface, finishing the sequence with a confirmation signal sent back to the operator indicating that manual control is now active and engaged.

On the other hand, the transition from the semi-auto/assisted manual mode 1390.4 back to the autonomous mode 1390.2 may necessitate an explicit and verifiable release of control from the human operator. The pre-transition condition may be initiated, for example, by a specific “release control” signal transmitted from the operator's console. Before accepting control, the supervisory system of the robot 1, e.g., the mode manager 1390, may perform a comprehensive system-wide self-check. This check may confirm that all navigational and sensory systems 1.2.8, such as the LiDAR and/or cameras, are nominal and functioning within their expected parameters, and that the state estimator of the robot 1 has converged with low uncertainty. The mode manager 1390 may also confirm with the onboard AI system 1470 (e.g., the Helix model and system 1476.2) that a valid autonomous goal or task is loaded, understood, and ready for execution. The transition protocol may therefore involve the robot 1 acknowledging the operator's release signal, successfully completing its internal self-check, loading the specified autonomous task into its planner 1302, and issuing a confirmation that it has assumed full control and is commencing the autonomous operation.

Transitions into the routine aspect of the maintenance mode 1390.6, for instance for the purpose of charging, may follow a separate protocol that is centered on an orderly shutdown and precise positioning. The pre-transition condition for this mode may specify that any active task has either been fully completed or safely suspended in a recoverable state. The robot 1 may also verify that a navigable path to the designated maintenance or charging station is clear of any obstructions. The transition protocol may therefore involve the robot 1 first indicating its intent to enter the non-task-oriented maintenance mode 1390.6. It may then autonomously navigate to the specified station, perform any docking or precise positioning maneuvers, and once it is physically secured, it enters the restricted maintenance state 1390.6 where most of its motive functions are disabled. This could be a state of being stable without power while the battery remains connected (3024), where the computing architecture 1000 may be de-energized, but the main battery remains connected for diagnostic or monitoring purposes. For more intensive maintenance procedures or in emergency situations, the state may be the engagement of an energy isolating device (e.g., a main disconnect switch, a circuit breaker, or a battery connector) (3022), where a physical disconnect is activated to ensure maximum safety for personnel, representing a highly secure stable position.

The transition to the fail-safe aspect of the maintenance mode 1390.6 is unique in that it may represent the highest-priority action available to the robot 1, capable of overriding all other states and protocols. This transition may not be dependent on a pre-transition stable position check; instead, it may be triggered immediately by either the detection of an unrecoverable system anomaly by the onboard diagnostics, or the activation of a manual emergency stop (E-Stop) command from an external source. This type of transition may be immediate and unconditional. In one example, power may be cut to all non-essential actuators, all physical brakes may be engaged. Alternatively, the robot 1 may attempt a controlled stop to reach a stable, low-energy posture, designed to prevent a dangerous collapse. The operational state at the precise moment of failure may be logged to a persistent memory for later diagnostics, and the robot 1 may enter a terminal state that mandates a formal, manual inspection and reset procedure before any other operational mode can be activated.

In alternative embodiments, the rule-based logic flow 3000 for verifying a stable position (e.g., at block 3003) may be replaced or supplemented by other advanced techniques. For example, an AI-driven transition management system may use a dedicated AI model to learn and predict safe handover postures based on high-dimensional state data, potentially commanding a specific learned maneuver (e.g., a “pre-teleop” crouch) rather than checking a static list of criteria. In another embodiment, probabilistic transition gating may be employed, wherein the mode manager 1390 computes a confidence level for a safe transition (e.g., using a Bayesian network) and permits the switch only if this probability exceeds a set threshold. Further, the check may be based on energy-based stability criteria, such as a formal Lyapunov stability analysis. This method can provide a verifiable, physics-based guarantee of stability.

### b. Second Embodiment of a Mode Manager

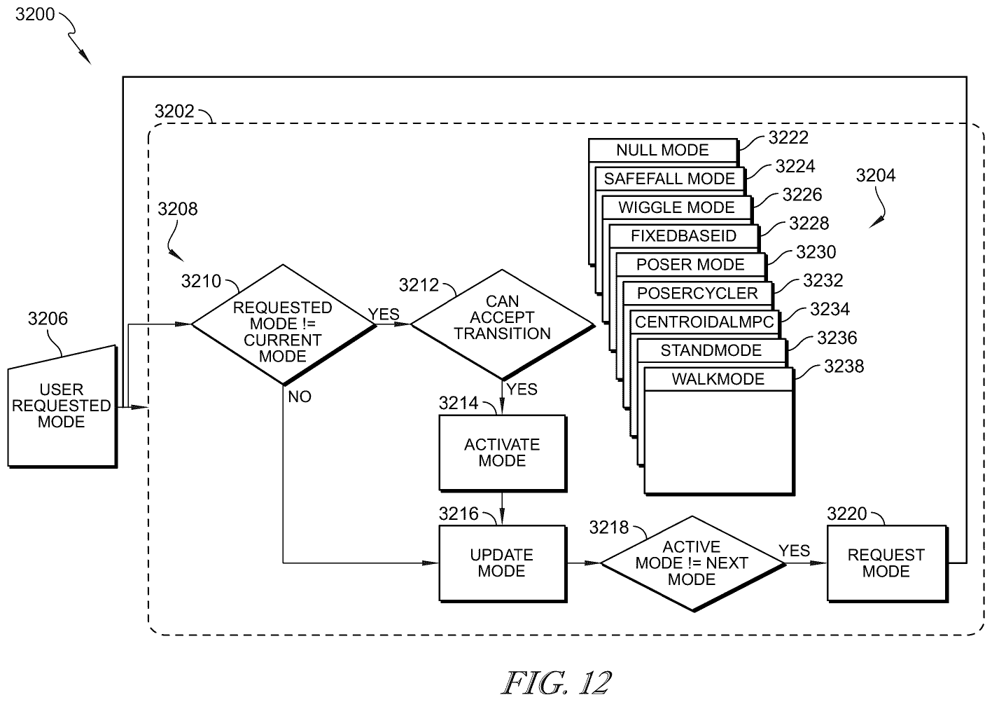

FIG. 12 is a diagram 3200 showing a second embodiment of a mode manager 3202 that may be established by the humanoid robot 1. The mode manager 3202 includes or otherwise references at least one, and preferably multiple or a plurality of mode(s), predetermined mode(s), controller mode(s), or robot mode(s) 3204. Each of the modes 3204 may be configured to implement a particular predetermined behavior, a defined range of behaviors, or another container of functionality for the humanoid robot 1. For example, the modes 3204 may include locomotion/manipulation controllers, various utility modes, and other specialized functionality. In some embodiments, each mode 3204 may be embodied as an object that implements a virtual interface associated with a robot mode. The virtual interface may include, for example, methods or other procedures for initializing the robot mode (e.g., a method that is called once after the construction of the robot mode object), determining whether the mode can accept a transition from another mode, activating the robot mode, and updating the robot mode (e.g., a method that is called once per robot control cycle or “tick”).

### i. Operational Modes

Specifically, the plurality of predetermined modes 3204 may include: (i) a null mode 3222, (ii) a safe fall mode 3224, (iii) a wiggle mode 3226, (iv) a fixed base ID mode 3228, (v) a poser mode 3230, (vi) a poser cycler mode 3232, (vii) a centroidal MPC mode 3234, (viii) a stand mode 3236, (ix) a walk mode 3238, (x) a gesture mode configured to execute a library of predefined social or informational gestures (e.g., waving, pointing) upon command, and/or (xi) any other similar mode or useful mode for robot operation. In some embodiments, the safe fall mode 3224 may be enhanced to be a multi-strategy safe fall mode. This enhanced mode may contain a library of multiple fall strategies and select the optimal one based on estimated fall dynamics, such as a “tuck and roll” 4312 for forward falls or a “brace for impact” 4314 for sideways falls.

The wiggle mode 3226, which may be useful for system bring-up, gain tuning, general joint-level debugging of the robot 1, and in general may allow for the rapid prototyping of other, more complex modes. The wiggle mode 3226 may allow for the control of a single degree of freedom or joint of the robot 1 in position control, with a setpoint, a waveform, and a trajectory provided as inputs. The wiggle mode 3226 may also allow for the control of a single degree of freedom or joint in force control, and/or the control of a single limb in Cartesian space (with a target position or a target force). In further embodiments, the wiggle mode 3226 may be evolved into a system identification mode. This mode may execute a series of designed motions (e.g., frequency sweeps) to automatically gather data for system identification, allowing for the precise calculation of the dynamic parameters of the robot 1 like joint friction and mass, which can then be used to improve model-based controllers. Inputs to the wiggle mode 3226 may include measured joint positions, velocities, torques, force/torque sensor readings, and other relevant data.

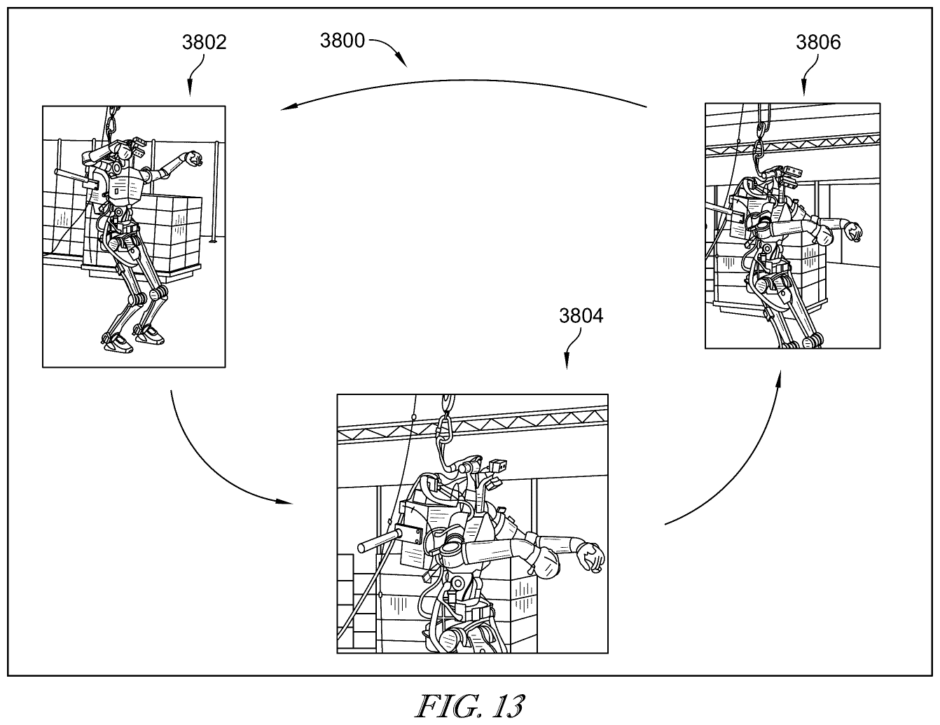

Referring now to FIG. 13, diagram 3800 illustrates one potential embodiment of the wiggle mode 3226. Graphics 3802, 3804, and 3806 illustrate a sequence of joint positions that the robot 1 may move between while operating in the wiggle mode 3226. As shown, the robot 1 may cycle through those positions, for example for a predetermined amount of time, until receiving a subsequent command, or until other specific conditions are met. While cycling between those positions, the robot 1 itself and/or a human operator may determine whether the robot 1 is operating correctly (i.e., correctly and accurately achieving the specified joint positions). Thus, the wiggle mode 3226 may allow for improved detection of failures during the robot wake-up sequence. If a failure is detected, the robot 1 may determine the severity of that failure and, based on the assessed severity, may take one or more corrective actions. For example, if the failure is of low severity, the robot 1 may proceed with its wakeup sequence but inform a cloud-based system of the error, and suggest that maintenance be scheduled for itself. Maintenance may be scheduled based on the severity—for example, higher severity failures may suggest maintenance immediately after the current shift is over, while lower severity failures may wait until the next scheduled robot update. If the robot 1 identifies a high-severity failure while in the wiggle mode 3226, the robot 1 may cancel its assigned work and immediately request maintenance.

The centroidal MPC mode 3234 may control the motion of the robot 1 using model predictive control, a technique which includes swing trajectory modeling for each foot of the robot 1. Further, the stand mode 3236 may control the balance state of the robot 1. Inputs to the stand mode 3236 may include various joint measurements (e.g., joint positions, velocities, torques, etc.) in addition to state estimation data regarding contact state, base pose, and forces from end effector force estimators. Also, the walk mode 3238 may control the walking of the robot 1 according to a detailed footstep plan that is provided by the planner 1302 or another component of the robot 1. As described further below, each of the robot modes 3204 may independently determine whether it can accept a transition based on a set of criteria specific to that particular mode 3204.

### ii. Operation of the Second Embodiment

The method 3300 begins with the construction of a mode manager object. In the illustrative embodiment, the mode manager 3202 may be embodied as a class that is defined in an object-oriented programming language. The mode manager object may be constructed, for example, during the initialization or startup sequence of the robot 1. The robot 1 then initializes the mode manager object. As part of this initialization, the robot 1 registers one or more robot modes with the mode manager 3202. For example, the mode manager 3202 object may include a map that is configured to reference multiple robot modes 3204. Each robot mode 3204 may be similarly embodied as an object that is constructed by the robot 1. The robot 1 may add a predetermined set or another collection of robot modes 3204 to the map, for example indexed by mode name for easy retrieval. The robot 1 initializes each of the registered robot modes 3204 and initializes an active robot mode pointer to reference one of the registered robot modes 3204. For example, the active robot mode pointer may be set to reference a default mode, a fallback mode, or another designated startup mode of the robot 1, such as the illustrative wiggle mode 3226 shown in FIG. 12. The robot 1 initializes a requested robot mode name and an active robot mode name. For example, the mode manager 3202 object may further include a member variable for each of the requested robot mode name and the active robot mode name. Each of those variables may initially be set to correspond to the name of the active robot mode pointer. As described above, the requested mode name may be set by a planner 1302, an autonomy system, or another component of the robot 1, for example by using one or more methods of the mode manager 3202 class.

After initializing the mode manager 3202, the robot 1 starts a control loop. The control loop executes periodically or otherwise executes multiple iterations to maintain continuous control. Each iteration of the control loop may be called a “tick.” During each iteration, the state of the robot 1 may be estimated, and its controls may be updated as described further below. The control loop may illustratively execute with a frequency between 1 Hz and 20 KHz, and the iteration frequency may be either constant or variable. As part of the control loop iteration, the robot 1 may update its robot state estimation.

Next, a user may provide a spoken command or other form of input to the robot 1. Based on that user input, the robot 1 generates a long-horizon goal, and then determines how to accomplish that long-horizon goal using one or more sub-tasks. The robot 1 may then provide the appropriate user requested modes 3206 to the mode manager 3202 in order to accomplish each individual sub-task. Additionally or alternatively, in some embodiments an autonomy system of the robot 1 (e.g., the autonomy interface 1352) may submit a requested mode 3206, for example by determining a long-horizon goal and/or one or more associated sub-tasks.

To obtain the requested mode, in block 3210, the robot 1 determines whether the current requested mode 3206 is different from the current mode recorded by the mode manager 3202 in block 3320. If the modes are the same, the method 3208 branches to block 3216, which is described further below. If the requested mode is different, the method 3208 branches to block 3212.

In block 3212, the robot 1 determines whether the requested mode 3204 can accept a transition based on the current state of the robot 1. The mode manager 3202 may, for example, identify the requested mode from the available modes 3204 and send a request (e.g., a method call) to that requested mode 3204 to determine whether it can accept a transition based on the current state of the robot 1. As described above, each mode 3204 may make an independent determination of whether that mode 3204 can accept a transition based on the current state of the robot 1. The requested mode 3204 may, for example, determine whether the current state of the robot 1 satisfies one or more predefined constraints that are established by the requested mode. Continuing the illustrative example shown in FIG. 13, to determine whether to accept a transition, the stand mode 3236 may determine whether both feet of the robot 1 are in contact with a surface, whether a desired velocity of the robot 1 is zero (e.g., a desired velocity originating from the planner 1302), and whether a measured velocity of the robot 1 is low (e.g., below a predetermined threshold value, such as below 0.2 m/s). As another example, to determine whether to accept a transition, the walk mode 3238 may determine whether at least one foot of the robot 1 is in contact with a surface, and whether the measured velocity of the robot 1 is below a predetermined maximum walking speed (e.g., <1.4 m/s). As described above, the various modes 3204 may establish different constraints or other criteria that are appropriate for the functionality of the corresponding mode 3204. Other modes (i.e., the safe fall mode 3224 or a fallback mode) may be configured to always accept a transition.

If the requested mode 3204 indicates that it can accept a transition, the method 3208 advances to block 3214. In block 3214, the robot 1 activates the requested mode 3206. When activated, the requested mode 3206 becomes the new current mode recorded by the mode manager 3202. Activating the requested mode 3206 may also allow that mode to initialize its internal state or otherwise prepare for execution. In block 3216, the robot 1 updates the currently active mode. When updated, the mode 3204 for the currently active mode may perform one or more control operations or otherwise control the behavior or other functionality of the robot 1. When updated, the currently active mode 3204 may access the state of the robot 1, including the estimated state and/or a measured state from one or more sensors or other data sources associated with the robot 1. When updated, the currently active mode 3204 may also update the desired state of the robot 1, for example by providing an updated state to the whole body controller 1550, the actuator controllers 600, and/or other control systems of the robot 1.

Referring again to block 3212, if the requested mode 3204 indicates that it cannot accept a transition, then the requested mode is not activated, and it may not be updated. In some embodiments, the previously active robot mode may simply remain active, and that previously active robot mode may be updated instead. This architecture may allow the control of the robot 1 to remain stable when the requested robot mode 3204 is not ready to be activated. In some embodiments, when the requested robot mode 3204 cannot accept the transition, the method 3208 may branch to a fallback mode selection as described below in connection with blocks 3218 and 3220. In block 3218, the robot 1 determines whether the currently active mode is not equal to the next mode. If so, then the method 3208 branches to block 3220, in which the mode manager 3202 posts an additional requested mode. The additional requested mode may be a designated fallback mode or another predetermined safe mode. Accordingly, blocks 3218 and 3220 may provide fallback logic for situations when the current or requested mode is unable to operate in the current state of the robot 1. After updating the current mode and, in some embodiments, executing fallback logic, the method 3208 is completed. The method 3208 may be executed again, for example during a subsequent controller tick or other controller iteration.

### c. Third Embodiment of a Mode Manager

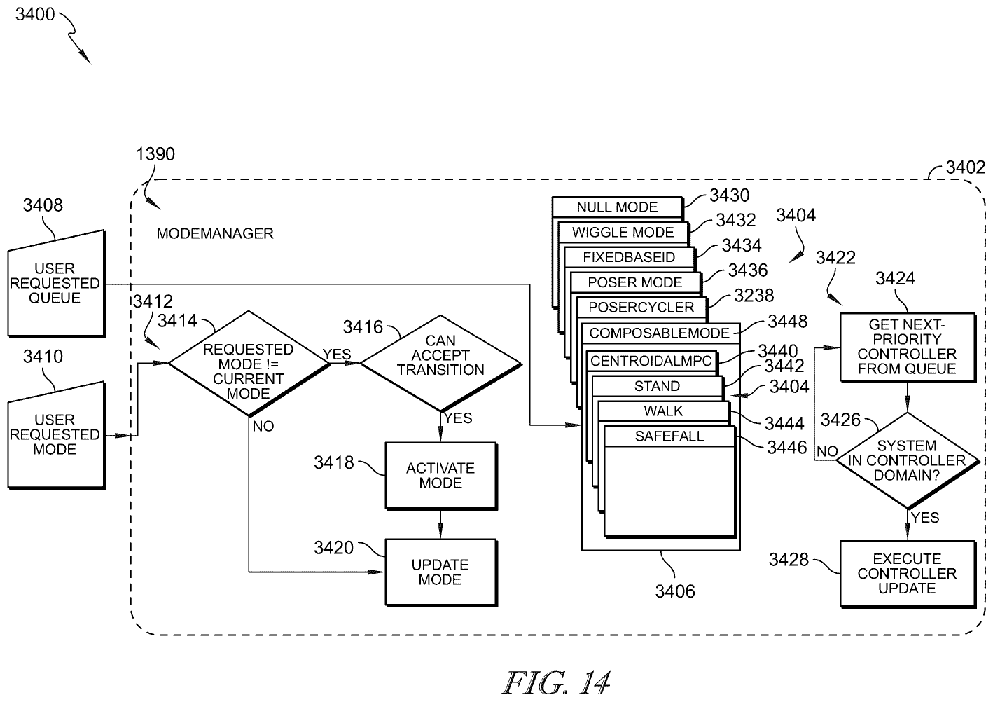

FIG. 14 illustrates a third embodiment of a mode manager 3402 that may be established by the humanoid robot 1. In contrast to the above mode managers, this mode manager implements a stateless, composable architecture.

### i. Operational Modes

As shown in FIG. 14, the mode manager 3402 includes or otherwise references one or more composable modes 3406. Each composable mode 3406 provides a sequential composition of multiple individual modes 3404. This mechanism of sequential composition provides a powerful way to sequence different modes 3404 together to create more complex behaviors. As described further below, each mode 3404 establishes a specific domain over which that mode 3404 can operate; that is, each mode 3404 establishes where in the overall state-space of the robot 1 that particular mode 3404 is valid. Each mode 3404 may be designed to attract or funnel the state of the robot 1 toward the domain of another mode 3404, thereby leading the state of the robot 1 progressively toward one or more desired goal states.

Each of the modes 3404 in this embodiment may be stateless, which is in contrast to the modes 3204 of FIG. 12 that may include internal state. Because each mode 3404 is stateless, the mode manager 3402 may transition between modes 3404 without executing additional complex transition logic, which may improve both the speed and the correctness of mode transitions. However, because each of the modes 3404 does not maintain its own state, the mode manager 3402 may provide access to robot state information that is accessible to each of the modes 3404. For example, in an illustrative embodiment, the mode manager 3402 may provide or otherwise reference a shared blackboard object that holds state information that may be accessed by any of the modes 3404. As such, a ‘stateless controller’ refers to a controller that does not maintain its own internal memory or state across control cycles. Instead, it operates as a pure function, calculating its output based only on the robot's current state, which is provided to it by a shared system component, such as a blackboard. Additionally or alternatively, the mode manager 3402 may provide state management using any other appropriate technique, such as one or more singleton manager objects that provide access to states of similar types, a context object that includes a superset of the state used by all of the modes 3404, a set of “named” objects, a subscriber model in which controllers may subscribe to published state information, or other similar techniques.

As described below, in some embodiments, the composable mode 3406 may be embodied as a priority queue of modes 3404. Each mode 3404 within the composable mode 3406 may be assigned a predetermined priority. As described further below, when multiple modes 3404 are capable of controlling the robot 1 in its current state, the mode 3404 having the highest priority is the one that is selected. Accordingly, complex behaviors that are robust in response to system perturbations may be defined by setting the priorities of the robot modes 3404 within a composable mode 3406. For example, a mode 3404 that includes a desired goal state within its operational domain may have the highest priority within a given composable mode 3406.

Continuing that example, lower-priority robot modes 3404 within the same composable mode 3406 may have larger domains that are designed to funnel the robot state toward the more constrained domain of the higher-priority mode 3404. Accordingly, each composable mode 3406 may include a lowest-priority mode 3404 having an infinite domain or otherwise being capable of controlling the robot 1 in any state, acting as a final fallback. Further embodiments of this composable architecture may enhance the selection logic. For example, instead of crisp Boolean domains, “fuzzy logic domains” may be used, allowing a state to have a degree of membership in multiple domains simultaneously, with controller outputs being blended. In another variation, “dynamic priority re-weighting” may be employed, where an overseer system adjusts the mode priorities based on task context (e.g., increasing the priority of a safe fall when carrying a payload). Additionally or alternatively, in some embodiments, the composable mode 3406 may be embodied as a behavior tree or another type of collection of modes 3404. As another alternative, ‘adaptive domains’ may be used, wherein the boundaries of a mode's 3404 domain are not fixed but can be learned or adjusted over time based on the robot's operational experience, allowing the system to refine its own stability boundaries.

The mode manager 3402 may be configured to register or otherwise reference multiple, predetermined composable modes 3406, each comprising a set of modes 3404. For example, in the illustrative embodiment, the individual modes 3404 may include a null mode 3430, a wiggle mode 3432, a fixed base ID mode 3434, a poser mode 3436, a poser cycler mode 3438, a centroidal MPC mode 3440, a stand mode 3442, a walk mode 3444, and a safe fall mode 3446. The wiggle mode 3432, for example, may be configured to command a predefined oscillatory motion in one or more joints for system diagnostics or gain tuning. Those modes 3404 may be functionally similar to the modes 3204 shown in FIG. 12; however, as described further below, in contrast to the modes 3204 of FIG. 12, the modes 3404 may be stateless and thus may allow for switching between modes 3404 without specialized transition logic. Additionally, a controller 3404 may be parameterizable, meaning that the same base mode 3404 may be used for multiple conditions (e.g., different step frequencies, heights, etc.).

### ii. Operation of the Third Embodiment

The mode manager 3402 further maintains a user-requested queue 3408 and a user-requested mode 3410, each of which may be embodied as a name or other identifier of one or more of the modes 3404 and/or composable modes 3406 associated with the mode manager 3402. Similar to the user-requested mode 3206 of FIG. 12, each of the user-requested queue 3408 and/or the user-requested mode 3410 may be provided by, for example, the planner 1302 or other components of the computing architecture 1000. Continuing that example, a user may provide a spoken command or other input to the robot 1. Based on that user input, the robot 1 generates a long-horizon goal, and then determines how to accomplish the long-horizon goal using one or more sub-tasks. To accomplish each sub-task, the robot 1 may then provide the appropriate user-requested queues 3408 and/or user-requested modes 3410 to the mode manager 3402. Additionally or alternatively, in some embodiments an autonomy system of the robot 1 (e.g., the autonomy interface 1352) may submit a requested queue 3408 and/or a requested mode 3410, for example by determining a long-horizon goal and/or one or more sub-tasks.

The mode manager 3402 further includes mode manager logic, which may include a method 3412 for managing the requested robot modes and queues. The method 3412 may be executed periodically or responsively by the robot 1. For example, in some embodiments, the method 3412 may be executed during every robot control cycle or “tick,” or may be otherwise regularly executed when controlling the robot 1. Additionally or alternatively, in some embodiments the method 3412 may be executed in response to one or more events, such as receiving a new user-requested mode or another requested mode change. The method 3412 starts in block 3414, in which the robot 1 determines whether the user-requested mode 3410 is different from the current mode recorded by the mode manager 3402. If the requested mode equals the current mode, the method 3412 branches to block 3420, described further below. If the requested mode does not equal the current mode, the method 3412 branches to block 3416.

In block 3416, the robot 1 determines whether the requested mode 3404 can accept a transition based on the current state of the robot 1. The mode manager 3402 may, for example, identify the requested mode 3404 and send a request (e.g., a method call) to that requested mode 3404 to determine whether the current state of the robot 1 is included in the operational domain of that mode 3404. As described above, the domain of each mode 3404 may be that specific part of the state-space of the robot 1 for which that mode 3404 is valid. The domain of a mode 3404 may also include a range of valid user input values. Accordingly, the domain of each mode 3404 may be represented using a common state-space and set of inputs, and the domain check operates on that common state-space. If the requested mode 3410 indicates that it can accept a transition (i.e., the system is within the domain of that mode 3404), the method 3412 branches to block 3418.

In block 3418, the robot 1 activates the requested mode 3410. When activated, the requested mode 3410 becomes the new current mode recorded by the mode manager 3402. Because each of the modes 3404 is stateless, the requested mode 3410 may be activated without state initialization or otherwise executing specialized transition logic. In block 3420, the robot 1 updates the currently active mode. When updated, the mode 3404 and/or the composable mode 3406 for the currently active mode may perform one or more control operations or otherwise control the behavior or other functionality of the robot 1. When updated, the currently active mode 3404 may access the state of the robot 1, including the estimated state and/or the measured state from one or more sensors or other data sources associated with the robot 1. For example, each mode 3404 may access one or more shared state objects that are accessible to all modes 3404. The shared state object(s) may be embodied as, for example, one or more singleton managers that provide access to objects of similar types, a context object providing a superset of state information that all modes may use, a set of named objects, a subscribe-publish model, or another suitable shared state system. When updated, the currently active mode 3404 may also update the state of the robot 1, for example, by providing an updated desired state to the whole body controller 1550, the actuator controllers 600, and/or other control systems of the robot 1. After updating the current mode, the method 3412 is completed. The method 3412 may be executed again, for example during a subsequent controller tick or other controller iteration.

Referring again to block 3416, if the requested mode 3404 indicates that it cannot accept a transition, then the requested mode may not be activated, and it may not be updated. Note that a composable mode 3406 may be designed to include a mode 3404 that has an infinite domain; thus, as described further below, the composable mode 3406 may always be capable of accepting the transition. Thus, in those embodiments, the robot 1 may always be able to identify a mode 3404 that is capable of accepting the transition.

The mode manager logic of the mode manager 3402 may further include a method 3422 for updating a composable mode 3406. The method 3422 may be executed periodically or responsively by the robot 1. For example, in some embodiments, the method 3422 may be executed during every controller update, for example in connection with blocks 3416-3420 of the method 3412 described above. Additionally or alternatively, in some embodiments the method 3422 may be executed in response to one or more events, such as receiving a new user-requested mode or another requested mode change.

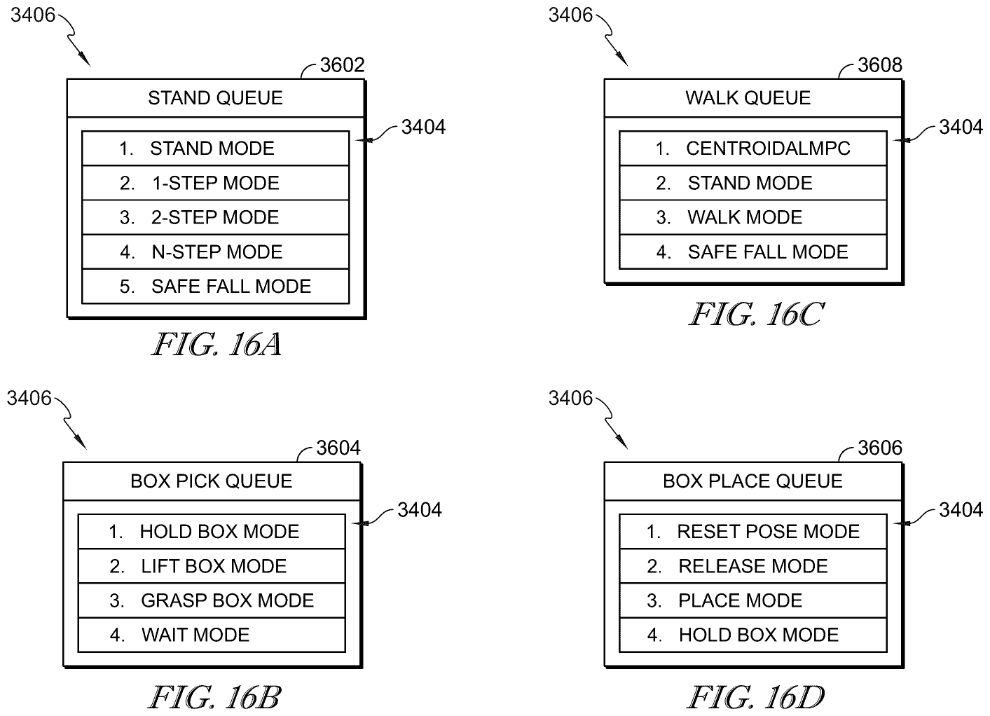

The method 3422 begins in block 3424, in which the robot 1 retrieves the highest priority mode 3404 that remains in a priority queue established by the active composable mode 3406. As described above, each mode 3404 of the composable mode 3406 may be assigned a predetermined priority. The robot mode 3404 having the highest priority may represent a goal state or another desired state of the robot 1. Lower-priority modes 3404 may represent intermediate states or fallback states of the robot 1. For example, in the illustrative composable mode 3406 shown in FIG. 16C, the centroidal MPC mode 3440 may have the highest priority of the modes 3404, and thus may be retrieved in the initial iteration of the method 3422.

In block 3426, the robot 1 determines whether the current state of the robot 1, including any user inputs, is within the domain of the retrieved mode 3404. As described above, a common state-space for the robot 1 may be established. Each mode 3404 establishes a domain over which that mode 3404 can operate; that is, each mode 3404 establishes where in the state-space of the robot 1 that mode 3404 is valid. If the current state of the robot 1 is not within the domain of the retrieved mode 3404, the method 3422 loops back to block 3424, in which the next-highest priority mode 3404 is retrieved from the priority queue of the composable mode 3406. For example, in the illustrative embodiment, if the centroidal MPC mode 3440 is not capable of accepting the transition, the robot 1 may retrieve the next-highest priority mode 3404, which is the stand mode 3442, and so on down the queue. If the current state of the robot 1 is within the domain of the selected mode 3404, the method 3422 advances to block 3428. Accordingly, the robot 1 may iterate through the priority queue of modes 3404 within the composable mode 3406 and select the highest-priority mode 3404 that is capable of controlling the present state of the robot 1. Thus, the robot 1 can perform complex behaviors in response to changing robot state, including robot state changes that are caused by external perturbations, to reach a goal state by sequentially composing the stateless modes 3404.

In block 3428, the robot 1 updates the selected mode 3404 from the composable mode 3406. When updated, the selected mode 3404 may perform one or more control operations or otherwise control the behavior or other functionality of the robot 1. When updated, the selected mode 3404 may access the state of the robot 1, including the estimated state and/or the measured state from one or more sensors or other data sources associated with the robot 1. When updated, the selected mode 3404 may also update the state of the robot 1, for example by providing an updated state to the whole body controller 1550, the actuator controllers 600, and/or other control systems of the robot 1. After updating the selected controller, the method 3422 is completed. The method 3422 may be executed again, for example during a subsequent composable controller update cycle.

### iii. Specific Example of Said Operation

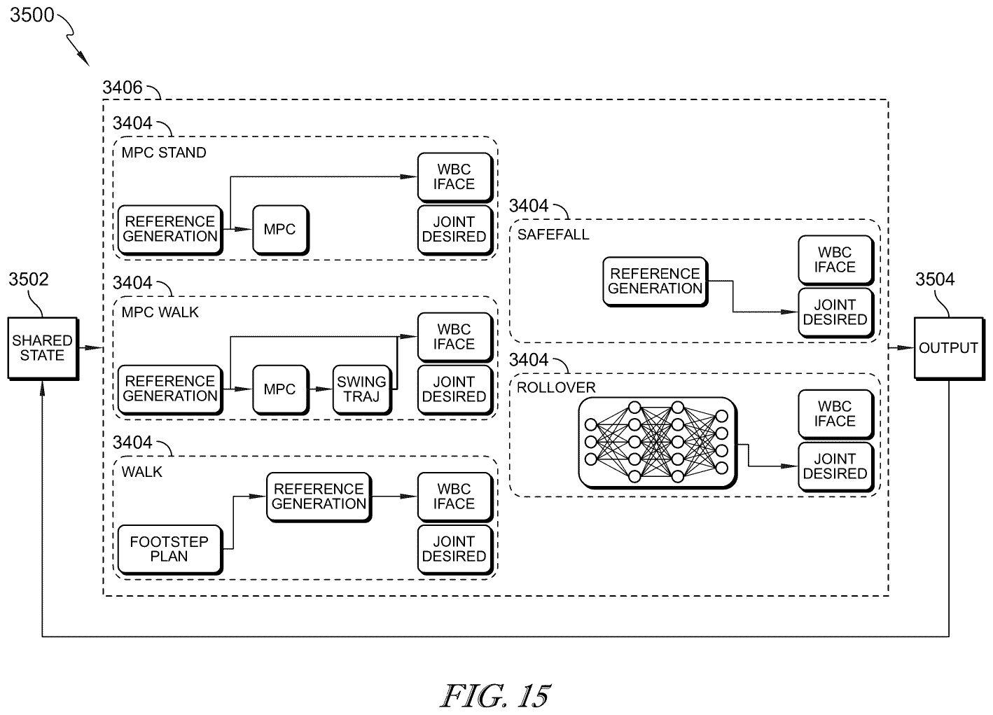

Referring to FIG. 15, diagram 3500 illustrates various modes 3404 included in a composable controller 3406 that may be used with the mode manager 3402 of FIG. 14. As shown, each of the modes 3404 may receive input from a shared state object 3502. As described above, the shared state 3502 may include measured joint positions, velocities, torques, force/torque sensor readings, and/or other measured robot state information. Additionally or alternatively, the shared state 3502 may include an estimated robot state, such as an estimated contact state, an estimated robot pose, an end effector force estimate, or another type of estimated state. Each of the modes 3404 produces an output 3504. The output 3504 may include changes to the desired robot state, including updates to the whole body controller interface and/or updates to individual joint controllers. As shown, the output 3504 may in turn update the shared state 3502, creating a closed-loop control system. As described above in connection with FIG. 15, the mode manager 3402 may sequentially compose the modes 3404 according to the valid domain of each mode 3404.

Referring to FIG. 16A-16D, diagrams 3600 illustrates various potential embodiments of composable modes 3406. Each composable mode 3406 is illustrated as a priority queue of individual modes 3404. An illustrative stand queue 3602 includes, for example, a stand mode, a 1-step mode, a 2-step mode, an N-step mode, and a safe fall mode, which are arranged in order of decreasing priority. Each of those modes 3404 has a corresponding domain, with the higher-priority states generally having a narrower or more constrained domain. For example, the stand mode domain may specify that two feet are on the ground, that the robot 1 possesses zero-step capturability, that the desired velocity is equal to zero, and that the robot 1 is not currently falling. Capturability may be determined, for example, using a predetermined dynamic model of the robot 1, which may or may not correspond to the model used with an MPC controller. The 1-step domain may specify that greater than or equal to one foot is on the ground, that the robot 1 has 1-step capturability, and that the robot 1 is not falling. The 2-step domain may specify that greater than or equal to one foot is on the ground, that the robot 1 has 2-step capturability, and that the robot 1 is not falling. The N-step domain may specify that greater than or equal to one foot is on the ground, and that the robot 1 is not falling. The safe fall domain may be infinite; the safe fall mode controller may be a fallback controller that is capable of controlling the robot 1 in any state.

An illustrative box pick queue 3604 includes a hold box mode, a lift box mode, a grasp box mode, and a wait mode, arranged in decreasing priority, as shown in FIG. 16B. The hold box domain may specify that the box is clear of obstacles, and that the box is close enough to the torso of the robot 1. The lift box domain may specify that the robot 1 is physically touching the box. The grasp box domain may specify that the robot 1 has a known box pose and that the robot 1 has a valid grasp plan, for example, from the planner 1302. The wait domain may be infinite.

An illustrative box place queue 3606 includes a reset pose mode, a release mode, a place mode, and a hold box mode, arranged in decreasing priority, as shown in FIG. 16D. The reset pose domain may specify that the target placement location for the box is clear of obstacles and that the box is currently close enough to the torso of the robot 1. The release domain may specify that the robot 1 is touching the box to a surface. The place domain may specify that the robot 1 has a known place location for the box, and that the robot 1 has a valid motion plan, for example, from the planner 1302. The hold box domain may be infinite.

An illustrative walk queue 3608 includes a centroidal model predictive control (MPC) mode, a stand mode, a walk mode, and a safe fall mode, arranged in decreasing priority, as shown in FIG. 16C. Each mode 3404 has a corresponding domain, with the higher-priority states having a narrower domain. For example, the centroidal MPC domain may include states where the MPC control can accurately model the current robot state. The stand and walk modes may be capable of controlling the robot 1 in more extensive or different domains using different underlying control schemes. The safe fall domain may be infinite; the safe fall mode controller may be a fallback controller capable of controlling the robot 1 in any state.

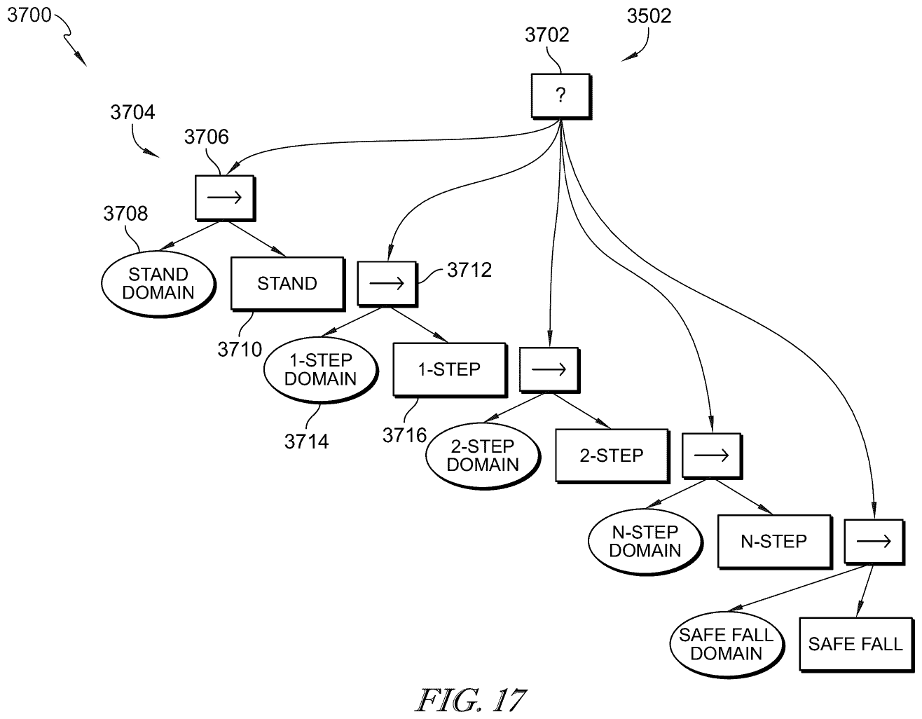

The illustrative composable modes 3406 shown in FIGS. 16A-16D may be used to perform one or more complex humanoid robot tasks, such as those shown in FIG. 12. As described above, in operation the computing architecture 1000 may determine the humanoid behaviors and actions to perform based on the processed user input data and humanoid data. To perform each task or sub-task, the robot 1 may select one of the composable modes 3406 and/or robot modes 3404 shown in FIG. 17. For example, as shown in graphic 3114 of FIG. 12, the robot 1 may initially select the stand queue 3602. With the stand queue 3602 active, the robot 1 attempts to achieve a goal state of standing stably in place, which is represented by the stand mode having the highest priority within the stand queue 3602. If the state of the robot 1 is perturbed, for example from an external force or another disturbance, one of the lower-priority modes like the 1-step mode, the 2-step mode, or the N-step mode may be temporarily activated to allow the robot 1 to regain its balance and return to the domain of the stand mode. If none of those modes can control the robot 1 in its current state (e.g., if the robot 1 is falling over), then the robot 1 may select the safe fall mode, which has the lowest priority and the largest domain.

If the robot 1 receives a command to pick a box from a shelf, then the robot 1 may generate a path and trajectory for going to the shelf, as shown in graphic 3116 of FIG. 12 or 14. The requested composable mode may be updated to the walk queue 3608 shown in FIG. 16C. When the walk queue 3608 is active, the robot 1 preferably selects the centroidal MPC mode to control its motion along the identified trajectory. If the centroidal MPC mode cannot control the current robot state, for example due to system perturbations, one of the less-preferred modes, such as the stand mode or the walk mode, may be selected. Once the system returns to a state that is within the domain of the centroidal MPC mode, control by the centroidal MPC mode resumes. If none of the centroidal MPC mode, the stand mode, or the walk mode can control the robot 1 in its current state (e.g., if the robot 1 is falling over), then the robot 1 may select the safe fall mode, which has the lowest priority.

After the robot 1 arrives at a shelf, the requested composable mode may be updated to the box pick queue 3604. In the box pick queue 3604, the desired goal state is the hold box mode, in which the robot 1 has already successfully grasped and lifted the box. When the robot 1 arrives at the shelf, the robot 1 may initially select the grasp box mode, in which the robot 1 controls its arms and end effectors to grasp the box. Once the robot 1 has successfully grasped the box, the robot 1 may select the next-higher priority mode, which is the lift box mode. After the robot 1 lifts the box, the robot 1 may select the hold box mode, which, as the highest-priority mode, represents the goal state of the box pick queue 3604. If the robot 1 is ever in a state that is outside of the domains of the hold box mode, the lift box mode, or the grasp box mode, the robot 1 may select the lowest-priority wait mode, in which the robot 1 may maintain a stable position and otherwise wait for the robot state to change.

After lifting and holding the box, the robot 1 may generate a path and trajectory for going to a destination for the box. The robot 1 may once again select the walk queue 3608 to control its locomotion to the destination, as described above. When the robot 1 reaches the destination, for example another shelf, the requested composable mode may be updated to the box place queue 3606. In the box place queue 3606, the desired goal state is the reset pose mode, in which the robot 1 has already placed the box and has returned to a predetermined stable pose. When the robot 1 arrives at the destination, the robot 1 may select the place mode, in which the robot 1 controls its arms and end effectors to move the box to a desired location, e.g., an empty position on the shelf. Once the robot 1 determines that the box is in the desired location, the robot 1 may select the next-higher priority mode, which is the release box mode. The robot 1 may then release the box from its end effectors, allowing the box to rest securely in the desired location. After the robot 1 releases the box, the robot 1 may select the reset pose mode, which, as the highest-priority mode, represents the goal state of the box place queue 3606. If the robot 1 is ever in a state that is outside of the domains of the reset pose mode, the release mode, or the place mode, the robot 1 may select the lowest-priority hold box mode, in which the robot 1 may maintain its hold on the box in a stable position and otherwise wait for the robot state to change.

Referring to FIG. 17, diagram 3700 illustrates a composable mode 3406 that is embodied as a behavior tree. As described above, in some embodiments, each composable mode 3406 may be embodied as a behavior tree rather than as a priority queue. The illustrative behavior tree 3700 of FIG. 17 corresponds to the stand queue 3602 of FIG. 16A. The illustrative behavior tree 3700 includes a fallback node 3702 with multiple sequential nodes as its children. Each sequential node, such as node 3706, includes a corresponding conditional node and a controller node as its own children. In the illustrative example, the evaluation of the behavior tree 3700 starts at the fallback node 3702 and traverses to the first sequential node 3706. The stand domain 3708 is evaluated, and if the current state of the robot 1 is within the stand domain 3708, the stand controller 3710 is selected and executed. If the current state is not within the stand domain 3708, then the evaluation of the behavior tree 3700 traverses to the next sequential node 3712, and the 1-step domain 3714 is evaluated. If the state is within the 1-step domain 3714, then the 1-step controller 3716 is selected. The evaluation of the behavior tree 3700 continues in this manner until a controller with a valid domain is found and selected. This behavior tree structure 3700 may be enhanced with more complex structures. These may include “Parallel Nodes” 4232, to manage concurrent tasks like walking and manipulating an object simultaneously, or “decorator nodes” 4234, which wrap a controller node to modify its behavior, such as by adding a “retry (n)” or “timeout” logic.

### d. Alternative Embodiments

Below are further alternatives or modifications to the above disclosed mode managers. It should be understood that any alteration disclosed below can be used with any other modification and/or system disclosed here.

### i. Alternative Operational Mode Paradigms

In an alternative embodiment, the discrete operational modes, such as the autonomous mode 1390.2, the semi-auto/assisted manual mode 1390.4, and the maintenance mode 1390.6, may be replaced by or augmented with a continuum of control paradigm. In this paradigm, the control architecture may not be partitioned into distinct, rigid modes but may exist on a continuous spectrum governed by a control authority parameter. Said parameter may be, for example, a floating-point value ranging from 0.0, representing fully manual control by a human operator, to 1.0, representing fully autonomous control by the onboard AI system 1470. The value of the control authority parameter may be adjusted in real-time by a human operator via a control interface or by a supervisory AI system. This supervisory system could modulate the parameter based on a quantitative analysis of task requirements, environmental complexity, or the estimation by the robot 1 of its own performance and confidence, thereby creating a fluid and adaptive control structure.

At intermediate values of the control authority parameter (e.g., a value of 0.5), the system may implement blended control, wherein control inputs from the human operator and decisions from the autonomous system are fused into a single, coherent set of actions. This fusion may not be merely an averaging of commands but a sophisticated synthesis. For example, a human operator utilizing a remote interface could provide high-level directional commands for the torso of the robot 1 and its intended direction of travel. The autonomous system, such as the whole body controller 1550, would interpret this intent and retain full authority over the complex, low-level execution, including the dynamic foot placement, precise joint torque application, and continuous balance maintenance to execute the operator's intent safely and efficiently.

In another embodiment, operational modes may be defined not by the source of control authority, but by the functional objective of the robot 1. These role-based operational modes would configure the entire software stack of the robot 1, from perception to planning, for a specific class of tasks. Such modes may include a logistics mode, wherein the planner 1302 and behavior controller 1350 are optimized for efficient path planning, obstacle avoidance in cluttered environments such as houses, and stable object manipulation for carrying and placing payloads. An assembly mode may be included that prioritizes high-precision manipulation, wherein the perception system may increase the update rate of sensors focused on the end-effectors, and the whole body controller 1550 may prioritize close-quarters stability and precise tool-tip control over rapid locomotion. Further modes may include an inspection mode 4016, focused on sensor data acquisition, wherein the planner 1302 would generate paths designed to maintain optimal sensor viewpoints and traverse difficult terrain, and a social interaction mode 4018, for safe and predictable interaction in human-centric spaces, wherein the robot 1 engages with humans through advanced speech recognition, gesture recognition, and emotional understanding, adapting its behavior to social context while constraining velocity and prioritizing legible gestures.

In a further embodiment, the system may include dedicated learning modes that extend beyond the data collection functionality of the semi-auto/assisted manual mode 1390.4. These modes are specifically designed for training and refining the onboard AI system 1470. Such modes may include a reinforcement learning (RL) mode, wherein the robot 1 is permitted to explore a task space through trial-and-error to optimize a control policy within a physically or virtually sandboxed environment where the mode manager 1390 would enforce strict safety boundaries. A shadow mode may also be included, wherein the robot 1 operates fully autonomously under the control of the autonomous mode 1390.2, while a human operator provides control commands in parallel, allowing the computing architecture 1000 to log the differences between the chosen actions of the autonomous system and the commands of the operator to create a dataset for offline policy improvement. An ‘active learning mode’ may also be provided, wherein the robot 1 identifies areas of high uncertainty in its models and autonomously generates and executes experiments to gather targeted data, for example, by testing the slipping point of its feet on a new floor surface within a safe, constrained motion.

In yet another embodiment, the singular maintenance mode 1390.6 may be expanded into a system of tiered fail-safe/degraded modes to provide a more granular response to off-nominal conditions. Such modes may include a limp-home mode, activated upon the detection of a non-critical hardware failure, wherein the robot 1 would retain partial functionality, such as slow walking, to autonomously navigate to a designated service area. A bracing mode may serve as a reactive mode triggered by an unrecoverable imbalance, wherein the robot 1 executes a pre-computed strategy to use its limbs to brace for impact and minimize damage. Additionally, an energy conservation mode 4036 may be a low-power state, less restrictive than the full maintenance mode 1390.6, wherein non-essential systems are powered down to conserve energy while the robot 1 is idle.

Further alternative operational modes may be provided to address specific scenarios. Such modes may include an exploration mode, wherein the robot 1 autonomously maps and explores unknown environments, prioritizing obstacle avoidance and data gathering, and a collaborative work mode, wherein specialized control logic facilitates teamwork and synchronized task execution with other robots or human partners. An introduction mode may be used to introduce the robot 1 to a user's home, in order to teach the robot 1 how the user likes their house organized. For example, the user may explain to the robot 1 where the cups go, how the bowls are to be stacked, and how the blanket should be draped over the couch. The data collected from these tasks can then be used by Robot 1 to perform the general instruction of clean up the house.

An energy conservation mode may reduce processing load and sensor usage to conserve battery life. A self-repair mode may allow the robot 1 to perform limited, autonomous diagnostic and maintenance tasks. For demanding tasks, a high-performance mode 4045 may temporarily boost computational and mechanical resources at the expense of accelerated battery consumption. Other specialized modes could include a security surveillance mode 4046, optimized for surveillance tasks; a delivery and transport mode 4047, for stably carrying goods; and an emergency response mode 4048, wherein the robot 1 rapidly transitions to a behavior set that prioritizes human safety and hazard mitigation.

Alternative safety and emergency features may be integrated into the control architecture of the robot 1. Such features may include automated emergency environment mapping, wherein the robot 1 immediately generates and transmits a map of its surroundings upon emergency mode activation. Soft-stop systems may utilize graceful shut-down protocols to reduce mechanical stress during abrupt stops. active balancing systems may allow the robot 1 to effect rapid internal mass redistribution or engage gyroscopic balancing mechanisms to recover from sudden stability perturbations. Finally, voice-activated emergency commands 4068 may configure the speech recognition system of the robot 1 to recognize and instantly act upon specific voice commands to trigger emergency protocols. In another alternative paradigm, the system may utilize task-priority operational logic. In this structure, the robot 1 does not operate in a single, high-level mode. Instead, the mode manager 1390 maintains a stack of active tasks, each with an assigned priority. The highest-priority task (e.g., ‘maintain balance’) may run at all times, while lower-priority tasks (e.g., ‘walk to destination,’ ‘grasp object’) are added or removed from the stack by the planner 1302. The observable ‘mode’ of the robot 1 is thus an emergent property of the combination of active tasks, allowing for more fluid and complex behavior without explicit, discrete mode transitions.

### ii. Modifications to the Mode Manager and its Logic

In an alternative embodiment, the mode manager 1390 may employ AI-Driven transition management. In this configuration, a dedicated AI model, such as a neural network or a decision forest, may replace or supplement the rule-based logic for verifying a “stable position” 3020. This AI model may be trained on extensive datasets of state information from successful and unsuccessful transitions to learn high-dimensional correlations that predict a safe handover. For example, when transitioning from autonomous mode 1390.2 to semi-auto/assisted manual mode 1390.4, the AI model might learn to command the robot 1 to perform a specific “pre-teleop” crouching maneuver-a posture it has determined through training to be optimally stable and receptive for handing over control to a human operator. This learned maneuver would be more robust and context-aware than a simple, hard-coded stable position check.

In another embodiment, the mode manager 1390 may utilize probabilistic transition gating. Instead of the binary stability check at block 3003, which yields a simple pass/fail result, the mode manager 1390 would employ a more nuanced probabilistic framework, such as a Bayesian network. This framework would compute the probability of a safe transition by integrating data from multiple sensors and accounting for their respective uncertainties. A mode switch would be permitted only if the computed confidence level exceeds a predefined and adjustable threshold (e.g., >99.9% probability of a successful and safe transition), allowing for a trade-off between operational speed and safety assurance.

In a further embodiment, the stability check at block 3003 may be replaced with energy-based stability criteria. This approach elevates the stability check from a simple kinematic check to a formal, physics-based criterion derived from control theory, such as Lyapunov stability. A transition would be permitted only if the total energy (potential and kinetic) of the robot 1 is below a certain threshold and the state of the robot 1 is determined to be within a mathematically defined basin of attraction for a stable fixed point in its state space. This provides a rigorous, verifiable guarantee of stability that is less susceptible to sensor noise or minor state estimation errors.

In yet another embodiment, the synchronous logic flow 3000 of FIG. 10 may be replaced by an asynchronous transition protocol. When the mode manager 1390 receives a requested mode at block 3002, it would immediately acknowledge the request and continue to operate in the current mode, ensuring no interruption to ongoing processes. In the background, a dedicated, non-blocking process would work to bring the robot 1 to the stable state. Once all prerequisites are met, the mode manager 1390 performs the switch at block 3006 and sends a completion notification to the requesting system, such as the planner 1302. This asynchronous approach prevents high-level planning systems from being blocked while waiting for the robot 1 to physically stabilize, which may lead to a more responsive and efficient overall system.

Further alternative embodiments of the mode manager 1390 may include a decentralized mode management system distributed across multiple subsystems for resilience and fault tolerance. A hierarchical mode manager may feature multiple levels of supervisory managers, with each layer responsible for different system constraints. Cloud-Based mode management 4146 may offload mode management decisions to cloud computing for more powerful decision-making. a blockchain-secured mode manager may provide secure, transparent logging of mode transitions and operational states for auditability.

Alternative transition strategies may include dynamic stability verification, using real-time physics simulations to validate stability states. Soft transitioning may provide gradual mode shifts with incremental handovers. Predictive transitioning may use machine learning models to anticipate transitions and prepare the systems of the robot 1 beforehand. An interruptible transition may allow for mid-transition intervention or abort mechanisms. Multi-Stage transitioning may break transitions into smaller incremental steps with checks at each phase.

Alternative software and algorithmic modifications may include real-time adaptive algorithms for real-time adjustment of internal parameters. Hybrid machine learning architectures may combine symbolic AI with deep learning. Federated learning may allow for distributed learning with multiple robots sharing knowledge securely. Meta-Learning systems may provide adaptable systems that quickly learn new operational modes. Self-Diagnostic AI agents may autonomously detect anomalies and trigger specific mode changes.

In a further modification, the mode manager 1390 may incorporate a context-aware fallback protocol. Instead of defaulting to a single, predefined fallback mode (e.g., a stand mode 3236) when a transition fails or an error occurs, the mode manager 1390 may select a fallback mode based on environmental or internal state. For example, if the robot 1 is on uneven terrain, the selected fallback may be a ‘bracing mode’ 4034 instead of ‘stand.’ If the robot 1 detects low-hanging obstacles, the fallback may be a low-energy crouch posture, providing a more robust safety response than a static default.

### iii. Alternative Composable Modes

In an alternative embodiment of the composable mode manager, the domain for each mode 3404 may be defined using fuzzy logic domains. Instead of a crisp Boolean boundary where the state of the robot 1 is either inside or outside a domain of a mode 3404, a state can have a degree of membership in multiple domains simultaneously. For example, the state of the robot 1 could be determined to have an 80% membership in the stand mode domain and a 30% membership in the 1-step mode domain. The outputs of the corresponding controllers could then be blended based on these membership degrees, resulting in smoother and more robust behavior at domain boundaries.

In another embodiment, the priorities within a composable mode queue, such as the stand queue 3602, may be subject to dynamic priority re-weighting. An overseer system within the mode manager 3402 could adjust the predetermined priorities based on the broader task context. For example, if the robot 1 is carrying a payload, the overseer system could increase the priority of the safe fall mode 3446 relative to the n-step recovery mode. This may cause the system to favor a controlled fall over a multi-step (e.g., more than three steps) recovery that might damage the payload or objects in the environment (e.g., house). In a further alternative, the n in the n-step recovery mode may be any value including zero. It may desirable to set the n is set to a very low number (like zero) to help prevent the robot 1 from stepping on other objects, people, etc., when it is trying to recover from a fall.

In a further embodiment, the selection logic within the composable mode manager 3402 may be implemented as a market-based mode selection architecture. Each mode 3404 may be implemented as an agent that “bids” for control of the robot 1 during each control cycle. The bid value may be a function of how well the current robot state fits the domain of the mode 3404 and the contextual importance of the mode 3404. The mode manager 3402 may act as an “auctioneer,” granting control to the highest-bidding mode 3404. This can replace the fixed priority queue logic of method 3422.

In yet another embodiment, the behavior tree structure 3700 may be enhanced with more complex advanced behavior tree structures. Such structures may include parallel nodes, which could be used to explicitly manage concurrent tasks by executing in parallel a locomotion-focused behavior tree and a manipulation-focused behavior tree, thereby allowing the robot 1 to walk while performing an arm task. Further enhancements may include decorator nodes, which wrap a controller node to modify its behavior, such as with a retry (n) decorator that re-attempts execution upon failure, or a timeout decorator that forces a failure if a controller takes too long to execute.

The architecture may also be modified to formally support parallel composable modes. In this embodiment, multiple composable mode queues may run in parallel, each dedicated to a different subsystem. For instance, a balancequeue could run constantly to manage locomotion and stability, while a separate manipulationqueue is activated on-demand for arm tasks. An arbitrator component would be required to resolve conflicts, such as when a requested manipulation task might compromise the robot's balance.

In another embodiment of the composable manager 3402, the domain check (e.g., at block 3426) may be enhanced to include resource-awareness. The definition of a mode's 3404 operational domain may incorporate not just the physical state of the robot 1, but also its internal resource state, such as remaining battery power or computational load. For example, the domain for a high-energy mode, such as the walk mode 3444, may contract as battery life decreases, causing the mode manager 3402 to select a lower-energy mode (e.g., stand mode 3442) even if the robot's physical state would otherwise permit walking. This integrates energy conservation directly into the high-frequency control logic.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/352,959, 19/355,393, 19/321,022, 19/355,531, 19/355,786, 19/357,879, 19/358,414, 19/362,617, and 19/363,293; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A system for managing operational modes of a humanoid robot, the system comprising:
a plurality of stateless controllers, each stateless controller associated with a predefined operational domain that defines a subset of a robot state-space wherein the stateless controller is valid;
at least one composable mode comprising a composable structure of two or more of the stateless controllers, arranged from a highest priority to a lowest priority; and
a mode manager communicatively coupled to the plurality of stateless controllers and configured to, for each control cycle of the robot:
iterate through the composable structure of an active composable mode, commencing from the highest-priority stateless controller;
select a first stateless controller encountered during the iteration whose predefined operational domain includes a current state of the humanoid robot; and
execute only the selected stateless controller to control the humanoid robot for the duration of the control cycle.

2. The system of claim 1, wherein the composable structure of the composable mode includes a fallback controller at the lowest priority, and wherein the operational domain of the fallback controller encompasses the entire robot state-space to ensure a stateless controller is selected in any robot state.

3. The system of claim 2, wherein the composable mode is a stand queue and the composable structure comprises, in order of decreasing priority:
a stand mode controller with a domain requiring zero-step capturability;
at least one step-recovery controller; and
a safe fall mode controller as the fallback controller.

4. The system of claim 3, wherein the mode manager is configured to:
select the at-least-one step-recovery controller in response to a perturbation moving the current state of the robot outside the operational domain of the stand mode controller; and
subsequently resume selection of the stand mode controller in a later control cycle when the current state of the robot re-enters the operational domain of the stand mode controller as a result of executing the step-recovery controller.

5. The system of claim 2, wherein the at least one composable mode is a walk queue, and the composable structure comprises, in order of decreasing priority: a centroidal model predictive control (MPC) mode controller, a stand mode controller, and the fallback controller.

6. The system of claim 1, wherein the composable mode is embodied as a behavior tree, and wherein iterating through the composable structure comprises traversing the behavior tree to find a valid controller.

7. The system of claim 1, further comprising an overseer system configured to perform dynamic priority re-weighting by adjusting the priorities of the stateless controllers in the composable structure based on a task context, wherein the task context includes whether the robot is carrying a payload.

8. The system of claim 1, wherein all stateless controllers in the composable mode access the current state of the robot from a shared state object or blackboard.

9. The system of claim 1, wherein the plurality of stateless controllers includes a “wiggle mode” controller, wherein the wiggle mode controller is configured to, when selected, command a predefined oscillatory motion in one or more joints of the humanoid robot for system diagnostics or gain tuning.

10. The system of claim 1, wherein the predefined operational domain of at least one stateless controller is resource-aware, wherein the domain dynamically contracts or expands based on an internal resource state of the robot, the internal resource state comprising at least one of: available battery power or current computational load.

11. A method for managing operational modes of a humanoid robot, the method comprising:
defining a plurality of stateless controllers, each associated with a predefined operational domain that defines a subset of a robot state-space wherein the controller is valid;
defining at least one composable mode comprising a composable structure of two or more of the stateless controllers, arranged from a highest priority to a lowest priority; and
executing a control loop wherein, for each control cycle:
iterating through the composable structure of an active composable mode, commencing from the highest-priority stateless controller;
selecting a first stateless controller encountered whose predefined operational domain includes a current state of the humanoid robot; and
executing only the selected stateless controller to control the humanoid robot for the duration of the control cycle.

12. The method of claim 11, further comprising:
including a fallback controller at the lowest priority in the composable structure; and
defining the operational domain of the fallback controller to encompass the entire robot state-space to ensure a stateless controller is always selected.

13. The method of claim 11, further comprising dynamically re-weighting the priorities of the stateless controllers in the composable structure based on a task context, the task context including whether the humanoid robot is carrying a payload.

14. The method of claim 11, wherein selecting the first stateless controller comprises:
in response to a perturbation, selecting a step-recovery controller whose domain is valid for the perturbed state; and
in a subsequent control cycle, automatically re-selecting a stand mode controller when the current state re-enters the operational domain of the stand mode controller.

15. A method for managing operational mode transitions in a humanoid robot, the method comprising:
receiving, at a mode manager, a request to transition from a current operational mode to a requested operational mode;
in response to the request, performing a stability check to verify if the humanoid robot is in a predefined stable state;
in response to the stability check failing, executing a corrective action to command the humanoid robot to actively move into the predefined stable state; and
gating the transition by switching control from the current operational mode to the requested operational mode only after the humanoid robot is verified to be in the predefined stable state, either from the initial stability check or following completion of the corrective action.

16. The method of claim 15, wherein the predefined stable state comprises a set of physical criteria, the physical criteria including that the humanoid robot is stationary, a center of mass of the robot is within a support polygon of the robot's feet, and a measured velocity of the robot is below a predefined threshold.

17. The method of claim 16, wherein the predefined stable state further comprises computational criteria and environmental criteria, wherein:
the computational criteria include performing a system-wide self-check of sensors and actuators; and
the environmental criteria include verifying a stable, low-latency communication link to a human operator's console when the requested mode is a semi-auto/assisted manual mode.

18. The method of claim 15, further comprising:
bypassing the stability check and the corrective action when the requested operational mode is an emergency fail-safe mode; and
switching control to the emergency fail-safe mode.

19. The method of claim 15, wherein:
performing the stability check is executed by a dedicated AI model trained to predict safe transition postures; and
executing the corrective action comprises commanding the robot to perform a learned “pre-handover” maneuver determined by the AI model to be an optimal posture for the mode transition.

20. The method of claim 15, wherein receiving the request is asynchronous, the method further comprising:
acknowledging the request while continuing to operate in the current operational mode;
performing the stability check and executing the corrective action, if needed, in a non-blocking background process; and
sending a completion notification to a requesting system only after the switch to the requested operational mode is complete.

21. The method of claim 15, further comprising in response to both the stability check failing and the corrective action also failing to achieve the predefined stable state, selecting a context-aware fallback mode from a plurality of available fallback modes based on a current environmental context.
